(19) United States
(12) Patent Application Publication
(10) Pub. No.: US 2013/0197786 A1
(43) Pub. Date: Aug. 1, 2013

(54) CONTROL APPARATUS AND CONTROL METHOD FOR MULTI-CYLINDER INTERNAL COMBUSTION ENGINE

(71) Applicant: Takeshi Genko, Toyota-shi (JP)

(72) Inventor: Takeshi Genko, Toyota-shi (JP)

(21) Appl. No.: 13/754,166

(22) Filed: Jan. 30, 2013

(30) Foreign Application Priority Data
Feb. 1, 2012 (JP) 2012-020068

(51) Int. Cl. F02D 41/00

(52) U.S. Cl. CPC F02D 41/00
USPC 701/108

(57) ABSTRACT

A control apparatus is provided for a multi-cylinder internal combustion engine that includes a plurality of cylinders, an exhaust passage, and an exhaust gas recirculation device including passages through which a part of exhaust gas discharged into the exhaust passage is recirculated individually to the respective cylinders. The control apparatus includes a control unit configured to execute an air-fuel ratio feedback control for controlling an exhaust gas air-fuel ratio to a target air-fuel ratio through feedback using a feedback correction amount. The control unit is configured to identify the cylinder corresponding to the passage in which a clogging occurs, among the plurality of passages, in a case where the clogging occurs in the passage among the plurality of passages, and to set the target air-fuel ratio according to a deviation of the feedback correction amount, the deviation corresponding to the identified cylinder.

### INCORPORATION BY REFERENCE

The disclosure of Japanese Patent Application No. 2012-020068 filed on Feb. 1, 2012 including the specification, drawings and abstract is incorporated herein by reference in its entirety.

### BACKGROUND OF THE INVENTION

1. Field of the Invention

The invention relates to a control apparatus and a control method for a multi-cylinder internal combustion engine including a plurality of cylinders, and more specifically to a control apparatus and a control method for a multi-cylinder internal combustion engine including an exhaust gas recirculation (EGR) device that recirculates a part of exhaust gas discharged into an exhaust passage, to the individual cylinders (combustion chambers).

2. Description of Related Art

In an exhaust system of an internal combustion engine (hereinafter also referred to as an engine) mounted on a vehicle or the like, a catalyst for purifying exhaust gas (e.g., a three-way catalyst) is provided. The catalyst is capable of purifying (converting) exhaust gas components most efficiently when an air-fuel ratio of exhaust gas flowing into the catalyst falls within a predetermined range. Accordingly, an air-fuel ratio sensor is disposed in an exhaust passage at a position upstream of the catalyst, and the amount of fuel injected from an injector is controlled through feedback based on a deviation between the air-fuel ratio detected by the air-fuel ratio sensor (the air-fuel ratio of the exhaust gas flowing into the catalyst) and a target air-fuel ratio (e.g., a stoichiometric air-fuel ratio) (main feedback control (main F/B control)). By executing the air-fuel ratio feedback control described above, it is possible to control the air-fuel ratio with high accuracy and achieve an improvement in exhaust gas emission.

In addition, what is called a sub feedback control (sub F/B control) is generally executed. In the sub feedback control, the air-fuel ratio of the exhaust gas having passed through the catalyst is detected based on the output value of an O₂ sensor (oxygen sensor) provided downstream of the catalyst, and the output of the above air-fuel ratio sensor is corrected.

In a multi-cylinder internal combustion engine including a plurality of cylinders, there are cases where an actual air-fuel ratio varies among the cylinders (an air-fuel ratio imbalance) resulting from a variation in the injection performance of injectors provided in the individual cylinders or a variation in intake air distribution amount among the cylinders and, when the above situation occurs, there are cases where an emission is deteriorated due to a deterioration of combustion of a specific cylinder. As a countermeasure against this, a method is adopted in which, by controlling the fuel injection amount in accordance with an inter-cylinder air-fuel ratio variation amount (an imbalance amount), the inter-cylinder air-fuel ratio imbalance is suppressed (see, e.g., Japanese Patent Application Publication No. 2005-133714 (JP-2005-133714 A)).

On the other hand, in the internal combustion engine mounted on the vehicle or the like, there is provided an EGR device in order to reduce NOx (nitrogen oxides) contained in the exhaust gas discharged from the combustion chamber. The EGR device suppresses the occurrence of NOx by recirculating a part of the exhaust gas discharged into an exhaust passage, as recirculated gas, to an intake passage via an EGR passage, mixing the recirculated gas into an air-fuel mixture, and thereby reducing a combustion speed and a combustion temperature. In addition, as the EGR device, there is a device including passages (the EGR passages) through which a part of the exhaust gas discharged into the exhaust passage is recirculated individually to the respective cylinders (see, e.g., Japanese Patent Application Publication No. 2010-025059 (JP-2010-025059 A)).

In the multi-cylinder internal combustion engine that includes the EGR device, in addition to the above air-fuel ratio imbalance amount, an EGR amount influences an air-fuel ratio feedback amount. In particular, in the multi-cylinder internal combustion engine that includes the EGR device including the passages (the EGR passages) through which the exhaust gas is recirculated individually to the respective cylinders, in a case where a deposit or the like is accumulated and a clogging occurs in one of the passages through which the exhaust gas is recirculated to the respective cylinders, it is not possible to obtain the desired EGR amount in the cylinder corresponding to the passage in which the clogging occurs (hereinafter also referred to as an EGR blockage cylinder), and hence there are cases where it is not possible to properly set the air-fuel ratio feedback amount.

### SUMMARY OF THE INVENTION

The invention provides a control apparatus and a control method for a multi-cylinder internal combustion engine, which properly execute an air-fuel ratio feedback control even when a clogging occurs in a passage among a plurality of passages through which exhaust gas is recirculated individually to the respective cylinders.

A first aspect of the invention relates to a control apparatus for a multi-cylinder internal combustion engine that includes a plurality of cylinders, an exhaust passage, and an exhaust gas recirculation device (an EGR device) including a plurality of passages (e.g., branch EGR passages) through which a part of exhaust gas discharged into the exhaust passage is recirculated individually to the respective cylinders. The control apparatus includes a control unit configured to execute an air-fuel ratio feedback control for controlling an exhaust gas air-fuel ratio to a target air-fuel ratio through feedback using a feedback correction amount, the control unit being configured to identify the cylinder corresponding to the passage in which a clogging occurs, among the plurality of passages, in a case where the clogging occurs in the passage among the plurality of passages, and to set the target air-fuel ratio according to a deviation of the feedback correction amount, the deviation corresponding to the identified cylinder.

More specifically, the control unit may be configured to set the target air-fuel ratio such that the target air-fuel ratio is leaner than a stoichiometric air-fuel ratio in a case where the clogging in the passage corresponding to the identified cylinder causes the deviation of the feedback correction amount to a rich side, and to set the target air-fuel ratio such that the target air-fuel ratio is richer than the stoichiometric air-fuel ratio in a case where the clogging in the passage corresponding to the identified cylinder causes the deviation of the feedback correction amount to a lean side.

Hereinbelow, effects of the invention will be described. First, the first aspect of the invention solves the problem that the excess or deficiency of the air-fuel ratio feedback correction amount is caused by the cylinder in which the EGR blockage occurs, due to an influence resulting from a hardware structure or the like during the air-fuel ratio feedback control. This point will be described below.

In a case where the air-fuel ratio of the exhaust gas is detected using one air-fuel ratio sensor in the multi-cylinder internal combustion engine, the exhaust gas discharged from a cylinder strongly contacts an element portion of the air-fuel ratio sensor, and the exhaust gas discharged from another cylinder weakly contacts the element portion of the air-fuel ratio sensor.

Thus, in the case where the exhaust gas from a cylinder strongly contacts the air-fuel ratio sensor and the exhaust gas from another cylinder weakly contacts the air-fuel ratio sensor, when the EGR blockage occurs, there are cases where the correction amount of the air-fuel ratio feedback control (the correction amount of the main feedback control, or the total correction amount of the main feedback control and the sub feedback control) is deviated to the rich side. For example, in a case where the EGR blockage occurs in the cylinder whose exhaust gas strongly contacts the air-fuel ratio sensor, the degree of leanness of the EGR blockage cylinder is greatly reflected in the overall exhaust gas air-fuel ratio. As a result, the degree of leanness of the overall exhaust gas air-fuel ratio (an average air-fuel ratio of all of the cylinders) calculated from the output signal of the air-fuel ratio sensor becomes larger than the degree of leanness of the actual exhaust gas air-fuel ratio (the pre-catalyst exhaust gas air-fuel ratio). When such a situation occurs, the correction amount of the air-fuel ratio feedback control is excessively increased (i.e., excessive correction occurs), and the correction amount is deviated to the rich side (i.e., rich deviation occurs). Consequently, the actual exhaust gas air-fuel ratio is deviated to the rich side with respect to the stoichiometric air-fuel ratio. When such rich deviation occurs, the emission amount of HC or CO is increased and an exhaust gas emission is deteriorated.

In addition, in the case where the EGR blockage occurs, there are cases where the correction amount of the air-fuel ratio feedback control is deviated to the lean side. For example, in a case where the EGR blockage occurs in the cylinder whose exhaust gas weakly contacts the air-fuel ratio sensor, an influence caused by the degree of leanness of the EGR blockage cylinder (an influence on the overall exhaust gas air-fuel ratio) is small, and hence the degree of leanness of the overall exhaust gas air-fuel ratio (the average air-fuel ratio of all of the cylinders) calculated from the output signal of the air-fuel ratio sensor becomes smaller than the degree of leanness of the actual exhaust gas air-fuel ratio (the pre-catalyst exhaust gas air-fuel ratio). When such a situation occurs, the correction amount of the air-fuel ratio feedback control becomes deficient, and the correction amount is deviated to the lean side (i.e., lean deviation occurs). Consequently, the actual exhaust gas air-fuel ratio is deviated to the lean side. When such lean deviation occurs, the emission amount of NOx is increased and the exhaust gas emission is deteriorated.

In order to solve the above problems, in the first aspect of the invention, in the case where a clogging occurs in a passage among the plurality of passages through which the exhaust gas is recirculated to the respective cylinders, the control unit identifies the cylinder corresponding to the passage in which the clogging occurs. Subsequently, the control unit sets (changes) the target air-fuel ratio of the air-fuel ratio feedback control (the target air-fuel ratio at the time of the EGR blockage) depending on the identified cylinder. Specifically, in the case where the clogging (EGR blockage) in the passage corresponding to the identified cylinder causes the deviation of the feedback correction amount to the rich side, the control unit sets the target air-fuel ratio such that the target air-fuel ratio is leaner than the stoichiometric air-fuel ratio. On the other hand, in the case where the clogging (EGR blockage) in the passage corresponding to the identified cylinder causes the deviation of the feedback correction amount to the lean side, the control unit sets the target air-fuel ratio such that the target air-fuel ratio is richer than the stoichiometric air-fuel ratio. By setting the target air-fuel ratio in this manner, it is possible to set the target air-fuel ratio of the air-fuel ratio feedback control with improved accuracy, and hence it is possible to suppress the deterioration of the exhaust gas emission.

In the above-described aspect of the invention, the control unit may be configured to set the target air-fuel ratio such that the target air-fuel ratio is leaner as an intake air amount is larger in the case where the clogging in the passage corresponding to the identified cylinder causes the deviation of the feedback correction amount to the rich side and the control unit sets the target air-fuel ratio such that the target air-fuel ratio is leaner than the stoichiometric air-fuel ratio. The control unit may be configured to set the target air-fuel ratio such that the target air-fuel ratio is richer as the intake air amount is larger in the case where the clogging in the passage corresponding to the identified cylinder causes the deviation of the feedback correction amount to the lean side and the control unit sets the target air-fuel ratio such that the target air-fuel ratio is richer than the stoichiometric air-fuel ratio.

In the above-described aspect of the invention, the control unit may be configured to set the target air-fuel ratio such that the target air-fuel ratio is leaner as a ratio of an inter-cylinder air-fuel ratio imbalance caused by the clogging in the passage is larger in the case where the clogging in the passage corresponding to the identified cylinder causes the deviation of the feedback correction amount to the rich side, and the control unit sets the target air-fuel ratio such that the target air-fuel ratio is leaner than the stoichiometric air-fuel ratio. In this case, the control unit may be configured to use the intake air amount and the imbalance ratio as parameters, and to set the target air fuel ratio such that the target air-fuel ratio is leaner as the intake air amount and the imbalance ratio are larger.

The control unit may be configured to set the target air-fuel ratio such that the target air-fuel ratio is richer as the ratio of the inter-cylinder air-fuel ratio imbalance caused by the clogging in the passage is larger in the case where the clogging in the passage corresponding to the identified cylinder causes the deviation of the feedback correction amount to the lean side and the control unit sets the target air-fuel ratio such that the target air-fuel ratio is richer than the stoichiometric air-fuel ratio. In this case, the control unit may be configured to use the intake air amount and the imbalance ratio as parameters, and to set the target air fuel ratio such that the target air-fuel ratio is richer as the intake air amount and the imbalance ratio are larger.

A second aspect of the invention relates to a control method for a multi-cylinder internal combustion engine that includes a plurality of cylinders, an exhaust passage, and an exhaust gas recirculation device including a plurality of passages through which a part of exhaust gas discharged into the exhaust passage is recirculated individually to the respective cylinders, wherein in the internal combustion engine, an air-fuel ratio feedback control is executed for controlling an exhaust gas air-fuel ratio to a target air-fuel ratio through feedback using a feedback correction amount. The control method includes determining whether or not a clogging occurs in a passage among the plurality of passages; identifying the cylinder corresponding to the passage in which the clogging occurs in a case where it is determined that the clogging occurs; and setting the target air-fuel ratio according to a deviation of the feedback correction amount, the deviation corresponding to the identified cylinder.

According to the above aspects of the invention, even when a clogging occurs in a passage among the passages through which the exhaust gas is recirculated individually to the respective cylinders, it is possible to set the target air-fuel ratio with high accuracy, and hence it is possible to properly perform the air-fuel ratio feedback control.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic structural view showing an example of a multi-cylinder engine to which the invention is applied;

FIG. 2 is a schematic structural view showing only one cylinder of the engine of FIG. 1;

FIG. 3 is a view showing a relationship between an output voltage of a front air-fuel ratio sensor and an air-fuel ratio;

FIG. 4 is a view showing a relationship between an output voltage of a rear O₂ sensor and an air-fuel ratio;

FIG. 5 is a block diagram showing a structure of a control system such as an electronic control unit (ECU) or the like;

FIG. 6 is a view showing an output waveform of the front air-fuel ratio sensor;

FIG. 7 is a flowchart showing an example of a control at the time of EGR blockage in an embodiment of the invention;

FIG. 8 is a view showing an example of a map for setting a target air-fuel ratio at the time of the EGR blockage in the embodiment of the invention;

FIG. 9 is a view showing another example of the map for setting the target air-fuel ratio at the time of the EGR blockage in the embodiment of the invention;

FIG. 10 is a flowchart showing another example of the control at the time of the EGR blockage in the embodiment of the invention;

FIG. 11 is a flowchart showing another example of the control at the time of the EGR blockage in the embodiment of the invention;

FIG. 12 is a view showing an example of a map for setting a fuel correction amount of an EGR blockage cylinder in the embodiment of the invention; and

FIG. 13 is a view showing another example of the map for setting the fuel correction amount of the EGR blockage cylinder in the embodiment of the invention.

### DETAILED DESCRIPTION OF EMBODIMENTS

Hereinbelow, an embodiment of the invention will be described on the basis of the drawings.

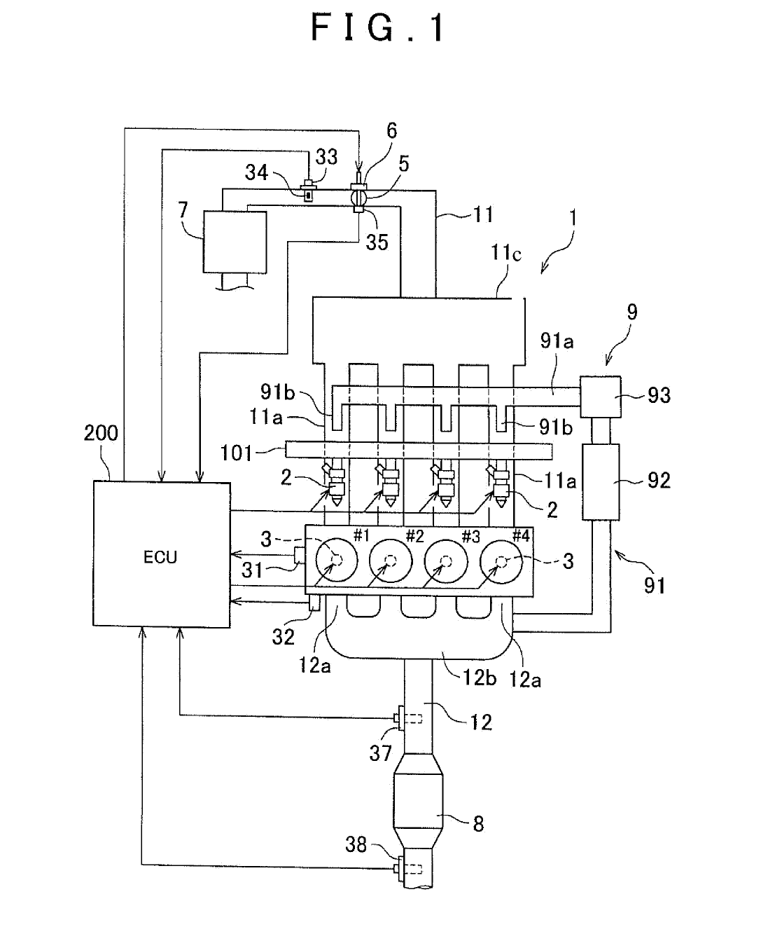

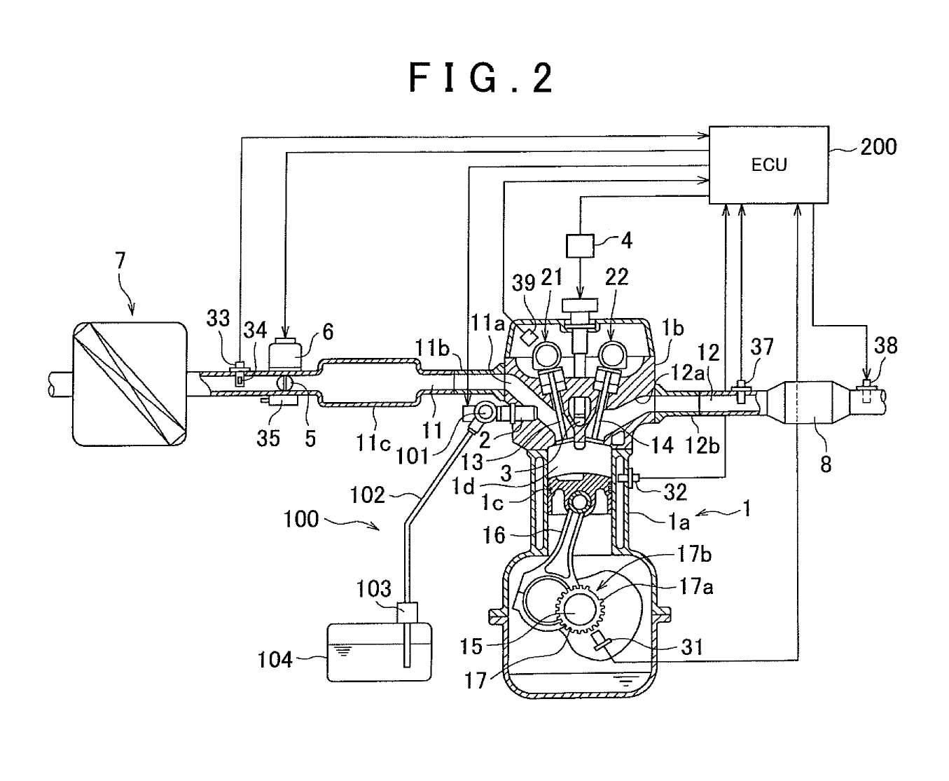

(Engine) Each of FIGS. 1 and 2 is a view showing a schematic structure of a multi-cylinder engine to which the invention is applied. Note that FIG. 2 shows only the structure of one cylinder of the engine. In addition, an EGR device is omitted in FIG. 2.

An engine 1 in this example is a port-injection four-cylinder engine (a spark-ignition internal combustion engine) mounted on a vehicle and, in a cylinder block 1a including cylinders #1, #2, #3, and #4 of the engine 1, there is provided a piston 1c that reciprocates in each cylinder in a top-bottom direction. The piston 1c is coupled to a crankshaft 15 via a connecting rod 16, and the reciprocation of the piston 1c is converted to the rotation of the crankshaft 15 by the connecting rod 16.

A signal rotor 17 is attached to the crankshaft 15. A plurality of teeth (protrusions) 17a are provided on the outer peripheral surface of the signal rotor 17 at regular angular intervals (e.g., 10° CA (crank angle) in this example). In addition, the signal rotor 17 has a no-tooth portion 17b that lacks two teeth 17a.

In the vicinity of the side of the signal rotor 17, a crank position sensor 31 that detects a crank angle is disposed. The crank position sensor 31 is, e.g., an electromagnetic pickup, and generates a pulsed signal (a voltage pulse) corresponding to the tooth 17a of the signal rotor 17 when the crankshaft 15 rotates. It is possible to calculate an engine rotational speed NE from the output signal of the crank position sensor 31.

In the cylinder block 1a of the engine 1, a coolant temperature sensor 32 that detects the temperature of engine coolant is disposed. In addition, a cylinder head 1b is provided at the upper end of the cylinder block 1a, and a combustion chamber 1d is provided between the cylinder head 1b and the piston 1c. A spark plug 3 is disposed in the combustion chamber 1d of the engine 1. The ignition timing of the spark plug 3 is adjusted by an igniter 4. The igniter 4 is controlled by an ECU 200.

To the combustion chamber 1d of the engine 1, an intake passage 11 and an exhaust passage 12 are connected. A part of the intake passage 11 is formed of an intake port 11a and an intake manifold 11b. A surge tank 11c is provided in the intake passage 11. In addition, a part of the exhaust passage 12 is formed of an exhaust port 12a and an exhaust manifold 12b.

In the intake passage 11 of the engine 1, there are disposed an air cleaner 7 that filters intake air, a hot-wire air flow meter 33, an intake air temperature sensor 34 (provided in the air flow meter 33), and a throttle valve 5 for adjusting the intake air amount of the engine 1. The throttle valve 5 is provided upstream of the surge tank 11c (upstream of the surge tank 11c with respect to an intake air flow) and is driven by a throttle motor 6. The opening of the throttle valve 5 is detected by a throttle opening sensor 35. The opening of the throttle valve 5 is controlled by the ECU 200.

A three-way catalyst 8 is disposed in the exhaust passage 12 of the engine 1. The three-way catalyst 8 has an O₂ storage function (an oxygen storage function) of storing (occluding) oxygen, and is capable of purifying HC, CO, and NOx with the oxygen storage function even when the air-fuel ratio is deviated from a stoichiometric air-fuel ratio to some extent. That is, when the air-fuel ratio of the engine 1 becomes lean and oxygen and NOx in the exhaust gas flowing into the three-way catalyst 8 are increased, the three-way catalyst 8 stores part of oxygen, and the reduction and purification (conversion) of NOx are thereby facilitated. On the other hand, when the air-fuel ratio of the engine 1 becomes rich and a large amount of HC and CO is contained in the exhaust gas flowing into the three-way catalyst 8, the three-way catalyst 8 releases oxygen molecules stored inside the three-way-catalyst 8 to give the oxygen molecules to HC and CO, and the oxidation and purification of HC and CO are thereby facilitated.

A front air-fuel ratio sensor 37 is disposed in the exhaust passage 12 at a position upstream of the three-way catalyst 8 (upstream of the three-way catalyst 8 with respect to an exhaust gas flow), and a rear O₂ sensor 38 is disposed in the exhaust passage 12 at a position downstream of the three-way catalyst 8.

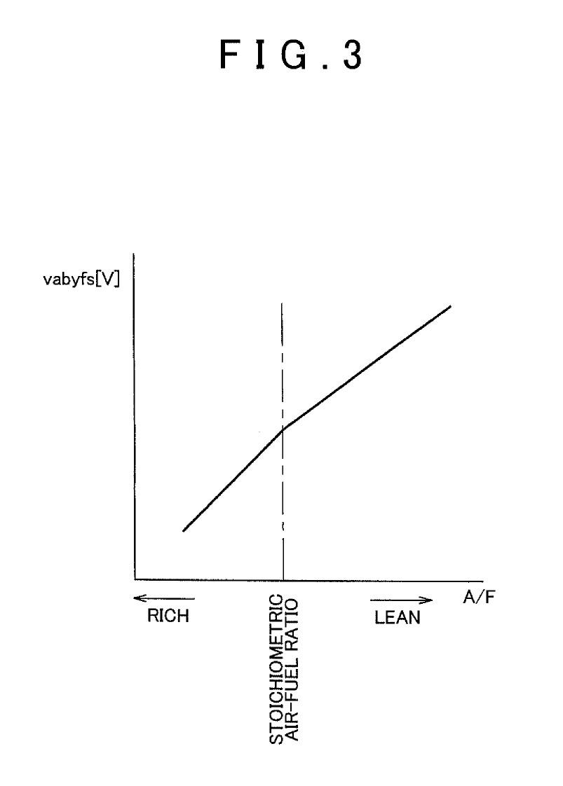

As the front air-fuel ratio sensor 37, for example, a limiting current type oxygen concentration sensor is used, and the front air-fuel ratio sensor 37 is capable of continuously detecting the air-fuel ratio in a wide air-fuel ratio range. FIG. 3 shows an output characteristic of the front air-fuel ratio sensor 37. As shown in FIG. 3, the front air-fuel ratio sensor 37 outputs a voltage signal vabyfs proportional to the detected air-fuel ratio (a pre-catalyst exhaust gas air-fuel ratio). In addition, the gradient of the characteristic (an air-fuel ratio-voltage characteristic) of the front air-fuel ratio sensor 37 changes at the stoichiometric air-fuel ratio.

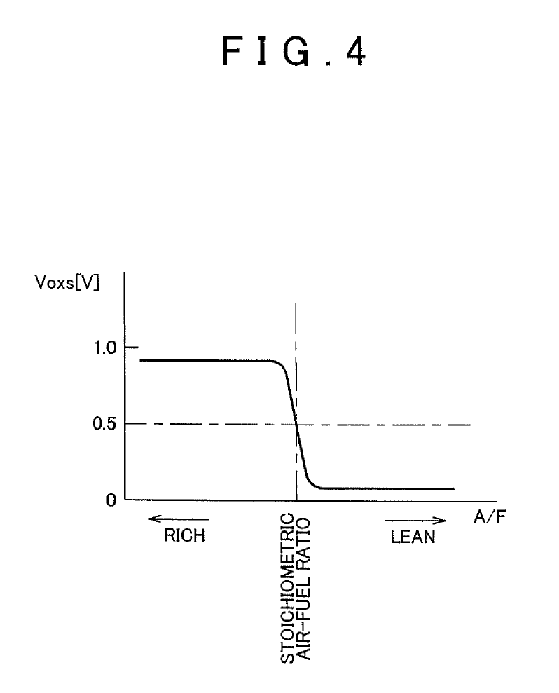

The rear O₂ sensor 38 is a sensor that displays a characteristic (Z characteristic) in which the output value changes stepwise in the vicinity of the stoichiometric air-fuel ratio. In this example, as the rear O₂ sensor 38, for example, an electromotive force (concentration cell) type oxygen concentration sensor is used. FIG. 4 shows an output characteristic of the rear O₂ sensor 38. As shown in FIG. 4, the rear O₂ sensor 38 outputs a voltage Voxs that sharply changes at the stoichiometric air-fuel ratio. More specifically, the rear O₂ sensor 38 is configured to output a voltage of, e.g., about 0.1 (V) when the air-fuel ratio is leaner than the stoichiometric air-fuel ratio, output a voltage of about 0.9 (V) when the air-fuel ratio is richer than the stoichiometric air-fuel ratio, and output a voltage of about 0.5 (V) when the air-fuel ratio corresponds to the stoichiometric air-fuel ratio.

The respective output signals of the front air-fuel ratio sensor 37 and the rear O₂ sensor 38 are input to the ECU 200.

An intake valve 13 is provided between the intake passage 11 and the combustion chamber 1d, and communication between the intake passage 11 and the combustion chamber 1d is allowed or interrupted by opening or closing the intake valve 13. In addition, an exhaust valve 14 is provided between the exhaust passage 12 and the combustion chamber 1d, and communication between the exhaust passage 12 and the combustion chamber 1d is allowed or interrupted by opening or closing the exhaust valve 14. The intake valve 13 and the exhaust valve 14 are opened and closed by the rotation of an intake camshaft 21 and an exhaust camshaft 22 to which the rotation of the crankshaft 15 is transmitted via a timing chain or the like.

In the vicinity of the intake camshaft 21, there is provided a cam position sensor 39 that generates a pulsed signal when the piston 1c of a specific cylinder (e.g., a first cylinder #1) reaches compression top dead center (TDC). The cam position sensor 39 is, e.g., an electromagnetic pickup, is disposed so as to face one tooth (not shown) on the outer peripheral surface of a rotor formed integrally with the intake camshaft 21, and outputs a pulsed signal (a voltage pulse) when the intake camshaft 21 rotates. Note that each of the intake camshaft 21 and the exhaust camshaft 22 rotates at a rotational speed that is a half (½) of a rotational speed of the crankshaft 15, and hence the cam position sensor 39 generates one pulsed signal every time the crankshaft 15 makes two rotations (i.e., every time the crankshaft 15 rotates by 720°).

In the intake port 11a of the intake passage 11, an injector (a fuel injection valve) 2 that injects fuel is disposed. The injector 2 is provided in each of the cylinders #1 to #4. The injectors 2 are connected to a common delivery pipe 101. Fuel stored in a fuel tank 104 of a fuel supply system 100 described later is supplied to the delivery pipe 101, and the fuel is injected into the intake port 11a from the injector 2. The injected fuel is mixed with intake air to generate an air-fuel mixture and the air-fuel mixture is introduced into the combustion chamber 1d of the engine 1. The air-fuel mixture (fuel+air) introduced into the combustion chamber 1d is ignited by the spark plug 3 and is combusted. By high-temperature and high-pressure combustion gas generated at this point, the piston 1c is caused to reciprocate, the crankshaft 15 is cause to rotate, and a driving force (output torque) of the engine 1 is thereby obtained. The combustion gas is discharged into the exhaust passage 12 as the exhaust valve 14 is opened. Note that, in the engine 1, the combustion occurs in the order of the first cylinder #1, the third cylinder #3, the fourth cylinder #4, and the second cylinder #2. The operation state of the engine 1 is controlled by the ECU 200.

On the other hand, the fuel supply system 100 includes the delivery pipe 101 connected to the injectors 2 of the individual cylinders #1 to #4, a fuel supply pipe 102 connected to the delivery pipe 101, a fuel pump (e.g., an electric pump) 103, and the fuel tank 104. The fuel stored in the fuel tank 104 is supplied to the delivery pipe 101 via the fuel supply pipe 102 by driving the fuel pump 103. By the fuel supply system 100 having the above structure, the fuel is supplied to the injector 2 of each of the cylinders #1 to #4.

In the fuel supply system 100 having the above structure, the operation of the fuel pump 103 is controlled by the ECU 200.

(EGR device) The engine 1 includes an EGR device 9. The EGR device 9 is a device that lowers the combustion speed and the combustion temperature in the combustion chamber 1d to reduce the generation amount of NOx by introducing a part of the exhaust gas into the intake air.

As shown in FIG. 1, the EGR device 9 includes an EGR passage 91, and an EGR cooler 92 and an EGR valve 93 that are provided in the EGR passage 91. The EGR passage 91 is constituted by a main EGR passage 91a, and branch EGR passages 91b that branch from the main EGR passage 91a. One end of the main EGR passage 91a (an end portion on a side opposite to a branch side) is connected to the exhaust manifold 12b, and the EGR cooler 92 and the EGR valve 93 are disposed in the main EGR passage 91a. The individual branch EGR passages 91b are connected to the intake ports 11a of the cylinders (#1, #2, #3, and #4), and the exhaust gas discharged into the exhaust passage 12 (the exhaust manifold 12b) is recirculated individually to the cylinders (the combustion chambers 1d) through the respective branch EGR passages 91b and the respective intake ports 11a.

In the EGR device 9 having the above structure, by adjusting the opening of the EGR valve 93, it is possible to change an EGR rate (EGR amount/(EGR amount+intake air amount (new air amount) (%)), and adjust the EGR amount introduced into the intake port 11a of each of the cylinders (#1, #2, #3, and #4) from the exhaust manifold 12b (the exhaust passage 12). The EGR amount of the EGR device 9 described above is adjusted by the ECU 200 (i.e., the EGR control is executed by the ECU 200). For example, the ECU 200 determines a target EGR rate (inclusive of a case where the EGR rate=0 is satisfied) by referring to a preset map based on the operation state of the engine 1 (e.g., the engine rotational speed and load), and controls the opening of the EGR valve 93 such that the actual EGR rate matches the target EGR rate.

Note that, in the EGR device 9, an EGR bypass passage that bypasses the EGR cooler 92 and an EGR bypass switching valve may be provided.

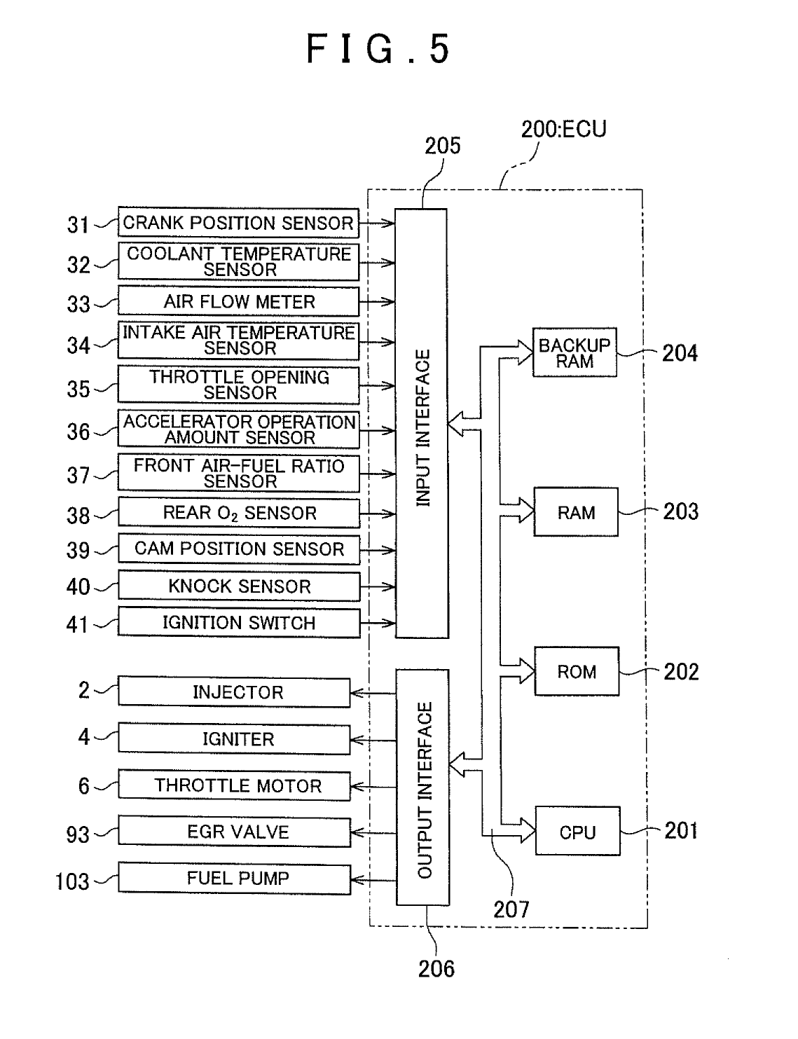

(ECU) As shown in FIG. 5, the ECU 200 includes a central processing unit (CPU) 201, a read only memory (ROM) 202, a random access memory (RAM) 203, and a backup RAM 204.

The ROM 202 stores various control programs and maps or the like that are referenced when the various control programs are executed. The CPU 201 executes various arithmetic processing operations based on the various control programs and maps stored in the ROM 202. In addition, the RAM 203 is a memory that temporarily stores the result of the arithmetic processing operation in the CPU 201 and data input from individual sensors, and the backup RAM 204 is a nonvolatile memory that stores, e.g., data that should be retained when the engine 1 is stopped.

The CPU 201, the ROM 202, the RAM 203, and the backup RAM 204 are connected to each other via a bus 207, and are also connected to an input interface 205 and an output interface 206.

To the input interface 205, there are connected various sensors such as the crank position sensor 31, the coolant temperature sensor 32, the air flow meter 33, the intake air temperature sensor 34, the throttle opening sensor 35, an accelerator operation amount sensor 36 that outputs a detection signal corresponding to an operation amount (a depression amount) of an accelerator pedal, the front air-fuel ratio sensor 37, the rear O₂ sensor 38, the cam position sensor 39, and a knock sensor 40 that detects a vibration generated during the combustion stroke of each of the cylinders (#1, #2, #3, and #4) of the engine 1 as a knocking signal (e.g., a voltage signal). In addition, an ignition switch 41 is connected to the input interface 205 and, when the ignition switch 41 is turned ON, cranking of the engine 1 by a starter motor (not shown) is started.

To the output interface 206, there are connected the injector 2, the igniter 4 of the spark plug 3, the throttle motor 6 of the throttle valve 5, the EGR valve 93 of the EGR device 9, and the fuel pump 103 of the fuel supply system 100.

Based on detection signals from the various sensors mentioned above, the ECU 200 executes various controls of the engine 1 including a drive control for the injector 2 (a fuel injection amount adjustment control), an ignition time control for the spark plug 3, and a drive control for the throttle motor 6 of the throttle valve 5 (an intake air amount control). Further, the ECU 200 executes a “cylinder recognition process”, an “air-fuel ratio feedback control”, an “inter-cylinder air-fuel ratio imbalance determination”, and a “control at the time of EGR blockage”.

With the programs executed by the ECU 200, the control apparatus for the multi-cylinder internal combustion engine of the invention is implemented.

(Cylinder recognition process) The cylinder recognition process executed by the ECU 200 will be described.

First, as shown in FIG. 2, in the signal rotor 17 used to detect the crank angle that is applied to this example, the teeth 17a are formed at intervals of, e.g., 10° CA, and the signal rotor 17 has thirty-four teeth 17a with two missing teeth. When the no-tooth portion 17b of the signal rotor 17 passes near the crank position sensor (the electromagnetic pickup) 31, the interval of generation of the voltage pulse is increased. By outputting a signal (a no-tooth signal) corresponding to the no-tooth portion 17b of the signal rotor 17, it is possible to detect the rotation phase of the crankshaft 15 (i.e., a crank position), and recognize time when the piston of each of the cylinders (#1, #2, #3, and #4) is positioned at the TDC. The output signal (the no-tooth signal) of the crank position sensor 31 corresponding to the no-tooth portion 17b of the signal rotor 17 serves as a signal for recognizing the TDC position for cylinder recognition, i.e., a “TDC position recognition signal”.

In a four-cycle engine (four-cylinder engine), two rotations of the crankshaft 15 (720° CA) that rotates in response to upward and downward movements of the piston 1c correspond to one engine cycle, and the piston of each cylinder is positioned at the TDC twice in each engine cycle. Consequently, it is not possible to determine at which of the two TDCs the piston of the cylinder is positioned, only with the output signal (the no-tooth signal) of the crank position sensor 31. In other words, it is not possible to perform the cylinder recognition. Consequently, in this example, the cylinder is recognized by combining the output signal (the voltage pulse) of the cam position sensor 39 with the output signal (the no-tooth signal) of the crank position sensor 31. Hereinbelow, the cylinder recognition will be described.

First, as described above, the crank position sensor 31 outputs the above no-tooth signal once (twice during one engine cycle) while the crankshaft 15 makes one rotation (360° CA). In this example, the crank position sensor 31 outputs the no-tooth signal at a predetermined crank angle before the piston of each of the first cylinder 41 and the fourth cylinder #4 is positioned at the TDC.

In addition, as described above, the cam position sensor 39 outputs the voltage pulse once (once during one engine cycle) while the crankshaft 15 makes two rotations. In this example, the cam position sensor 39 outputs the voltage pulse when the piston of the first cylinder #1 is positioned at the compression TDC and the piston of the fourth cylinder #4 is positioned at exhaust TDC.

With the above configuration, in a case where the cam position sensor 39 generates the voltage pulse when the crank position sensor 31 outputs the no-tooth signal, the piston of the first cylinder #1 is positioned at the compression TDC and the piston of the fourth cylinder #4 is positioned at the exhaust TDC. In addition, in a case where the cam position sensor 39 does not generate the voltage pulse when the crank position sensor 31 outputs the no-tooth signal, the piston of the first cylinder #1 is positioned at the exhaust TDC and the piston of the fourth cylinder #4 is positioned at the compression TDC. Thus, the voltage pulse generated by the cam position sensor 39 serves as a signal for performing the cylinder recognition (recognizing the cylinder), i.e., a “cylinder recognition signal”.

Thus, based on the no-tooth signal of the crank position sensor 31 (the first detection of the TDC position recognition signal) and the presence or absence of the cylinder recognition signal (the voltage pulse) of the cam position sensor 39 corresponding to the detection, it is possible to perform the cylinder recognition (crank angle determination) within a period when the crankshaft 15 makes one rotation at the latest. By the cylinder recognition, it is possible to recognize the piston position (intake stroke, compression stroke, combustion stroke, and exhaust stroke) of each of the cylinders #1 to #4 to perform accurate engine operation controls such as the fuel injection control and the ignition time control during the start of the engine or the operation after the start.

Note that, in the following processes, although the cylinder recognition (the crank angle determination) and the recognition of the piston position of each of the cylinders #1 to #4 are performed using the output signals of the crank position sensor 31 and the cam position sensor 39, the cylinder recognition (the crank angle determination) and the recognition of the piston position of each of the cylinders #1 to #4 may also be performed by other conventional methods.

(Air-fuel ratio feedback control) The ECU 200 executes the air-fuel ratio feedback control (a stoichiometric control) in which the oxygen concentration in the exhaust gas is calculated based on the outputs from the front air-fuel ratio sensor 37 and the rear O₂ sensor 38 disposed in the exhaust passage 12 of the engine 1, and the amount of the fuel injected into the combustion chamber 1d from the injector 2 is controlled such that the actual air-fuel ratio obtained from the calculated oxygen concentration matches a target air-fuel ratio (e.g., the stoichiometric air-fuel ratio). Specific processes of the air-fuel ratio feedback control will be described.

First, the three-way catalyst 8 exerts the function of oxidizing unburned components (HC, CO) and, at the same time, reducing nitrogen oxides (NOx) when the air-fuel ratio substantially corresponds to the stoichiometric air-fuel ratio (e.g., A/F=about 14.6±0.2). In addition, as described above, the three-way catalyst 8 has the function of storing oxygen (the oxygen storage function, the O₂ storage function), and is capable of purifying HC, CO, and NOx with the oxygen storage function even when the air-fuel ratio is deviated from the stoichiometric air-fuel ratio to some extent. That is, in a case where the air-fuel ratio of the engine 1 becomes lean and a large amount of NOx is contained in the exhaust gas flowing into the three-way catalyst 8, the three-way catalyst 8 takes oxygen molecules from NOx, stores the oxygen molecules, and thus, reduces NOx to purify (convert) NOx. In addition, in a case where the air-fuel ratio of the engine 1 becomes rich and a large amount of HC and CO is contained in the exhaust gas flowing into the three-way catalyst 8, the three-way catalyst 8 gives stored oxygen molecules to HC and CO, and thus oxidizes HC and CO to purify (convert) HC and CO.

Consequently, in order for the three-way catalyst 8 to efficiently purify a large amount of HC and CO continuously flowing into the three-way catalyst 8, the three-way catalyst 8 is required to store a large amount of oxygen and, in order for the three-way catalyst 8 to efficiently purify a large amount of NOx continuously flowing into the three-way catalyst 8, the three-way catalyst 8 is required to be capable of storing a sufficient amount of oxygen. As is clear from the foregoing, the purification capability of the three-way catalyst 8 depends on the maximum amount of oxygen that can be stored in the three-way catalyst 8 (the maximum oxygen storage amount).

On the other hand, the three-way catalyst 8 is degraded by poisoning by lead and sulfur contained in the fuel or heat applied to the three-way catalyst 8, and the maximum oxygen storage amount is gradually lowered with the degradation. In order to maintain good emission even when the maximum oxygen storage amount is lowered, the air-fuel ratio of gas discharged from the three-way catalyst 8 needs to be controlled to be extremely close to the stoichiometric air-fuel ratio.

Accordingly, in this example, the air-fuel ratio feedback control is executed. Specifically, a main feedback control for bringing the air-fuel ratio of the exhaust gas upstream of the three-way catalyst 8 (upstream of the three-way catalyst 8 with respect to the exhaust gas flow) to a value close to the stoichiometric air-fuel ratio based on the output of the front air-fuel ratio sensor 37 and a sub feedback control for compensating for the deviation in the main feedback control based on the output of the rear O₂ sensor 38 are combined and executed.

In the main feedback control, an increase and a decrease in the fuel injection amount from the injector 2 are adjusted such that the air-fuel ratio of the exhaust gas detected based on the output of the front air-fuel ratio sensor 37 matches the stoichiometric air-fuel ratio. More specifically, when the detected air-fuel ratio of the exhaust gas is richer than the stoichiometric air-fuel ratio, the fuel injection amount is decreased and, when the detected air-fuel ratio of the exhaust gas is leaner than the stoichiometric air-fuel ratio, the fuel injection amount is increased.

According to the above main feedback control, in theory, it is possible to maintain the air-fuel ratio of the exhaust gas flowing into the three-way catalyst 8 at the stoichiometric air-fuel ratio. Subsequently, if such a state is strictly maintained, the amount of stored oxygen of the three-way catalyst 8 is maintained at a substantially constant value, and hence it is possible to completely prevent the outflow of the exhaust gas containing the unburned component to an area downstream of the three-way catalyst 8.

A certain error is included in the output of the front air-fuel ratio sensor 37. In addition, there is a certain variation in the injection characteristic of the injector 2. As a result, realistically, it is difficult to control the air-fuel ratio of the exhaust gas upstream of the three-way catalyst 8 such that the air-fuel ratio thereof matches the stoichiometric air-fuel ratio only by executing the main feedback control.

For this reason, even when the main feedback control is executed, there are cases where the exhaust gas containing the unburned component flows out to the area downstream of the three-way catalyst 8. In other words, even when the main feedback control is executed, there are cases where the overall air-fuel ratio of the exhaust gas upstream of the three-way catalyst 8 is deviated to the rich side or the lean side. As a result, there are cases where rich exhaust gas containing HC or CO or lean exhaust gas containing NOx flows out to the area downstream of the three-way catalyst 8.

When such an outflow of the exhaust gas occurs, the rear O₂ sensor 38 generates a rich output or a lean output according to the air-fuel ratio of the exhaust gas. When the rich output is generated from the rear O₂ sensor 38, it is possible to determine that the overall air-fuel ratio of the exhaust gas upstream of the three-way catalyst 8 is deviated to the rich side and, when the lean output is generated from the rear O₂ sensor 38, it is possible to determine that the overall air-fuel ratio thereof is deviated to the lean side.

In the sub feedback control, when the output of the rear O₂ sensor 38 has a value indicative of the air-fuel ratio leaner than the stoichiometric air-fuel ratio, a sub feedback correction amount is determined by executing proportional integral processing (PI or PID processing) on the deviation between the output Voxs of the rear O₂ sensor 38 and a target value Voxsref that substantially corresponds to the stoichiometric air-fuel ratio. Subsequently, the feedback control is executed such that the output vabyfs of the front air-fuel ratio sensor 37 is corrected by the amount corresponding to the sub feedback correction amount, the actual air-fuel ratio of the engine 1 is thereby set to be apparently leaner than the detected air-fuel ratio of the front air-fuel ratio sensor 37, and the corrected apparent air-fuel ratio matches the target air-fuel ratio (the target air-fuel ratio of the engine 1, the stoichiometric air-fuel ratio in this example).

Similarly, when the output Voxs of the rear O₂ sensor 38 has a value indicative of the air-fuel ratio richer than the stoichiometric air-fuel ratio, the sub feedback correction amount is determined by executing the proportional integral processing (PI or PID processing) on the deviation between the output Voxs of the rear O₂ sensor 38 and the target value Voxsref that substantially corresponds to the stoichiometric air-fuel ratio. Subsequently, the feedback control is executed such that the output vabyfs of the front air-fuel ratio sensor 37 is corrected by the amount corresponding to the sub feedback correction amount, the actual air-fuel ratio of the engine 1 is thereby set to be apparently richer than the detected air-fuel ratio of the front air-fuel ratio sensor 37, and the corrected apparent air-fuel ratio matches the target air-fuel ratio (the target air-fuel ratio of the engine 1, the stoichiometric air-fuel ratio in this example).

With the above controls, the air-fuel ratio of the exhaust gas at a position downstream of the three-way catalyst 8 matches the target air-fuel ratio (substantially the stoichiometric air-fuel ratio) at the position.

(Inter-cylinder air-fuel ratio imbalance determination) Next, an inter-cylinder air-fuel ratio imbalance determination method (a common method) will be described.

In a case where an abnormality that influences all of the cylinders #1 to #4 of the engine 1 occurs in the fuel supply system such as the injector 2 or the like or an air system such as the air flow meter 33 or the like, the absolute value of the correction amount of the main feedback control of the air-fuel ratio is increased, and hence the abnormality can be detected by monitoring the absolute value thereof using the ECU 200.

For example, during the air-fuel ratio feedback control (during the stoichiometric control), in a case where the overall fuel injection amount is deviated from a stoichiometric equivalent amount by 5% (i.e., the fuel injection amount is deviated from the stoichiometric equivalent amount by 5% in all of the cylinders #1 to #4), the feedback correction amount of the main feedback control becomes a value that corrects the deviation amount of 5%, i.e., becomes the correction amount corresponding to −5%. Thus, it is possible to detect that the deviation of 5% occurs in the fuel supply system or the air system, using the feedback correction amount. When the feedback correction amount becomes equal to or larger than a predetermined determination threshold value, it is possible to detect the abnormality in the fuel supply system or the air system.

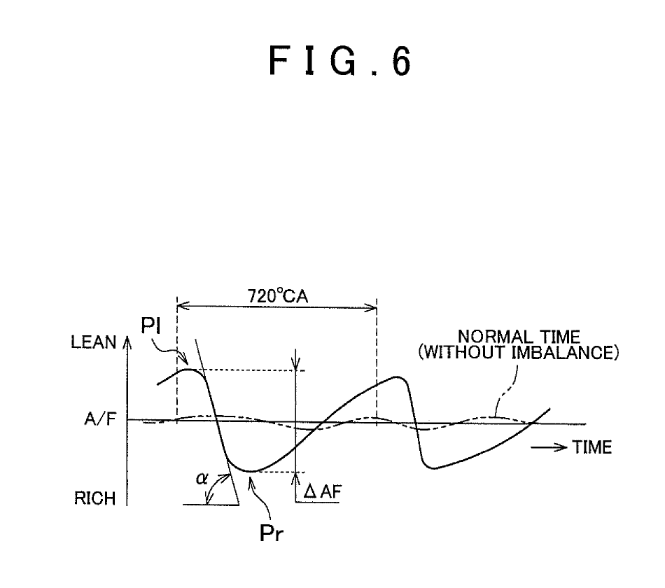

On the other hand, there are cases where the fuel supply system or the air system is not deviated as a whole but an air-fuel ratio variation (imbalance) among cylinders occurs. For example, there are cases where the actual air-fuel ratio varies among cylinders due to a variation in the injection performance of the injectors 2 provided in the individual cylinders and the manner in which exhaust gas contacts the front air-fuel ratio sensor 37 (i.e., the manner in which exhaust gas contacts an element portion of the front air-fuel ratio sensor 37). The manner in which exhaust gas contacts the front air-fuel ratio sensor 37 varies due to the attachment position of the front air-fuel ratio sensor 37. In a case where the inter-cylinder air-fuel ratio imbalance occurs, a fluctuation in exhaust gas air-fuel ratio in one engine cycle (=720° CA) is increased and the output of the front air-fuel ratio sensor 37 is fluctuated. FIG. 6 shows an example of an output waveform of the front air-fuel ratio sensor 37. In FIG. 6, the waveform in a one-dot chain line indicates a state at a normal time, i.e., a state in which the air-fuel ratio imbalance does not occur, while the waveform in a solid line indicates a state in which the air-fuel ratio imbalance occurs.

As shown in FIG. 6, the output waveform of the front air-fuel ratio sensor 37 (hereinafter also referred to as an A/F sensor output waveform) tends to oscillate relative to the stoichiometric air-fuel ratio and, when the inter-cylinder air-fuel ratio imbalance occurs, the amplitude of the oscillation of the A/F sensor output waveform is increased in accordance with the degree of the imbalance. By utilizing this phenomenon, it is possible to determine the presence or absence of the inter-cylinder air-fuel ratio imbalance. Hereinbelow, an example of the imbalance determination method will be described.

(1) As described above, by utilizing the fact that the amplitude of the oscillation of the output waveform of the front air-fuel ratio sensor 37 is larger as the inter-cylinder air-fuel ratio imbalance is larger, i.e., the fact that the gradient of the A/F sensor output waveform is larger as an imbalance ratio is larger (see FIG. 6), it is determined whether or not the inter-cylinder air-fuel ratio imbalance occurs from the gradient of the A/F sensor output waveform.

Specifically, based on the output signal of the front air-fuel ratio sensor 37, the A/F sensor output waveform is monitored and the gradient of the A/F sensor output waveform (an A/F gradient α in a section from a lean peak Pl to a rich peak Pr: see FIG. 6) is acquired. Subsequently, the A/F gradient α of the A/F sensor output waveform is compared with a predetermined determination threshold value (gradient) and, when the A/F gradient α (an absolute value) is equal to or larger than the predetermined determination threshold value, it is determined that the imbalance state occurs among cylinders. With regard to the determination threshold value used for the imbalance determination, for example, the upper limit of a range in which the air-fuel ratios among the cylinders of the engine 1 can be determined to be balanced is acquired by means of experiment, calculation, or the like, and a value obtained based on the upper limit is used as the determination threshold value.

In addition, based on the A/F gradient α of the A/F sensor output waveform, it is possible to determine the imbalance ratio (%) among the cylinders. The imbalance ratio (the ratio of imbalance) is a parameter related to the degree of the inter-cylinder air-fuel ratio variation, and is a value indicative of the ratio by which the air-fuel ratio of a cylinder in which the air-fuel ratio deviation occurs (an imbalance cylinder) deviates from the air-fuel ratio (equivalent to the stoichiometric air-fuel ratio) of a cylinder in which the air-fuel ratio deviation does not occur (a balance cylinder) in a case where the air-fuel ratio deviation occurs in only one cylinder among a plurality of cylinders.

Note that, in the A/F sensor output waveform shown in FIG. 6, it is also possible to acquire the gradient of the section from the rich peak to the lean peak and determine whether or not the imbalance state occurs based on the acquired A/F gradient.

(2) Based on the output signal of the front air-fuel ratio sensor 37, the A/F sensor output waveform (see FIG. 6) is monitored, and the value of the air-fuel ratio when the lean peak Pl of the A/F sensor output waveform is reached (a lean peak value AFa) is acquired. Next, the value of the air-fuel ratio when the rich peak Pr of the A/F sensor output waveform is reached (a rich peak value AFb) is acquired, a difference ΔAF between the lean peak value AFa and the rich peak value AFb (ΔAF=|AFa−AFb|: see FIG. 6) is determined, and it is determined that the imbalance state occurs among the cylinders when the difference ΔAF is equal to or larger than a predetermined determination threshold value.

Note that, instead of using the difference ΔAF between the lean peak and the rich peak, it is also possible to measure time between two adjacent lean peaks (or between two adjacent rich peaks) and determine whether or not the inter-cylinder air-fuel ratio imbalance state occurs based on the measured time between the peaks.

(EGR blockage cylinder) Next, an EGR blockage cylinder will be described.

In the four-cylinder engine 1 shown in FIG. 1, the EGR passage 91 is branched for each of the cylinders (#1, #2, #3, and #4) and each of the branch EGR passages 91b is connected to the intake port 11a of the corresponding cylinder, whereby the exhaust gas is introduced individually into the respective cylinders. In the engine 1 having the above structure, in a case where a deposit or the like is accumulated and a clogging occurs (that is, an EGR blockage occurs) in one of the branch EGR passages 91b (hereinafter, a cylinder corresponding to the branch EGR passage 91b in which a deposit or the like is accumulated and a clogging occurs may be referred to as an EGR blockage cylinder), the desired EGR amount is not obtained in the EGR blockage cylinder (that is, the degree of leanness of the exhaust gas air-fuel ratio of the EGR blockage cylinder is increased), and hence there are cases where it is not possible to properly set the air-fuel ratio feedback amount. Hereinbelow, this point will be described.

In a case where the air-fuel ratio (the pre-catalyst exhaust gas air-fuel ratio) of the exhaust gas from the four cylinders #1 to #4 of the engine 1 is detected by one front air-fuel ratio sensor 37, the exhaust gas discharged from a cylinder strongly contacts the element portion of the front air-fuel ratio sensor 37, and the exhaust gas discharged from another cylinder weakly contacts the element portion of the front air-fuel ratio sensor 37, for example, due to an influence resulting from a hardware structure (e.g., the attachment position of the front air-fuel ratio sensor 37).

Thus, in the case where the exhaust gas from a cylinder strongly contacts the front air-fuel ratio sensor 37 and the exhaust gas from another cylinder weakly contacts the front air-fuel ratio sensor 37, when the EGR blockage occurs, there are cases where the total correction amount of the main feedback control and the sub feedback control is deviated to the rich side. For example, in a case where the EGR blockage occurs in the cylinder whose exhaust gas strongly contacts the front air-fuel ratio sensor 37 (e.g., the first cylinder #1 or the third cylinder #3), the degree of leanness of the EGR blockage cylinder is greatly reflected in the overall exhaust gas air-fuel ratio. As a result, the degree of leanness of the overall exhaust gas air-fuel ratio (an average air-fuel ratio of all of the cylinders) calculated from the output signal of the front air-fuel ratio sensor 37 becomes larger than the degree of leanness of the actual exhaust gas air-fuel ratio (the pre-catalyst exhaust gas air-fuel ratio). When such a situation occurs, the correction amount of the main feedback control is excessively increased (i.e., excessive correction occurs) and, in a case where the excess of the correction amount cannot be corrected in the sub feedback control (e.g., in a case where the exhaust gas discharged from the cylinder, in which the EGR blockage occurs, weakly contacts the rear O₂ sensor 38), the total feedback correction amount (the correction amount of (the main feedback control+the sub feedback control)) is deviated to the rich side (i.e., rich deviation occurs). Consequently, the exhaust gas air-fuel ratio is deviated to the rich side. That is, the phrase “the feedback correction amount is deviated to the rich side (the deviation of the feedback correction amount to the rich side)” signifies that the feedback correction amount is deviated in such a manner that the actual exhaust gas air-fuel ratio is deviated to the rich side relative to the stoichiometric air-fuel ratio (i.e., the actual exhaust gas air-fuel ratio becomes richer than the stoichiometric air-fuel ratio). When such rich deviation occurs, the emission amount of HC or CO is increased and an exhaust gas emission is deteriorated.

In addition, in the case where the EGR blockage occurs, there are cases where the total correction amount of the main feedback control and the sub feedback control is deviated to the lean side. For example, in a case where the EGR blockage occurs in the cylinder whose exhaust gas weakly contacts the front air-fuel ratio sensor 37 (e.g., the second cylinder #2 or the fourth cylinder #4), an influence caused by the degree of leanness of the EGR blockage cylinder (an influence on the overall exhaust gas air-fuel ratio) is small, and hence the degree of leanness of the overall exhaust gas air-fuel ratio (the average air-fuel ratio of all of the cylinders) calculated from the output signal of the front air-fuel ratio sensor 37 becomes smaller than the degree of leanness of the actual exhaust gas air-fuel ratio (the pre-catalyst exhaust gas air-fuel ratio). When such a situation occurs, the correction amount of the main feedback control becomes deficient and, in a case where the deficiency of the correction amount cannot be corrected in the sub feedback control (e.g., in a case where the exhaust gas discharged from the cylinder, in which the EGR blockage occurs, strongly contacts the rear O₂ sensor 38), the total feedback correction amount is deviated to the lean side (i.e., lean deviation occurs). The phrase “the feedback correction amount is deviated to the lean side (the deviation of the feedback correction amount to the lean side)” signifies that the feedback correction amount is deviated in such a manner that the actual exhaust gas air-fuel ratio is deviated to the lean side relative to the stoichiometric air-fuel ratio (i.e., the actual exhaust gas air-fuel ratio becomes leaner than the stoichiometric air-fuel ratio). When such lean deviation occurs, the emission amount of NOx is increased and the exhaust gas emission is deteriorated.

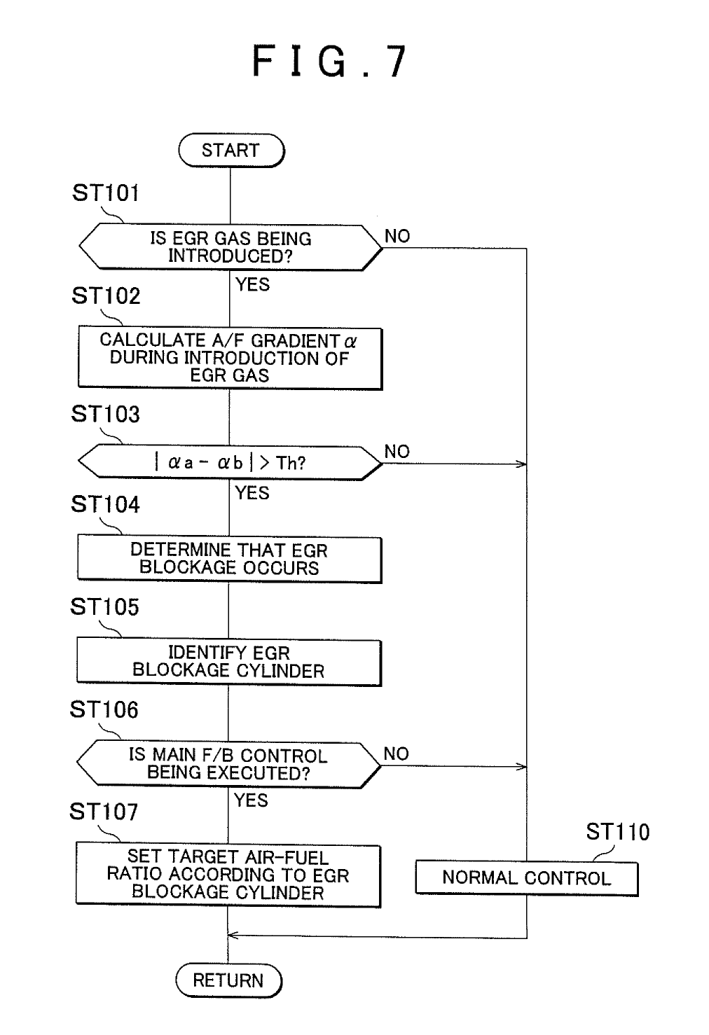

(Control at the time of EGR blockage) In order to solve the above problems, in the embodiment, in a case where a clogging occurs in a branch EGR passage 91b among the branch EGR passages 91b corresponding to the four cylinders (#1, #2, #3, and #4), the cylinder corresponding to the branch EGR passage 91b in which the clogging occurs (the EGR blockage cylinder) is identified. Subsequently, the target air-fuel ratio in the air-fuel ratio feedback control is set to a value on the lean side or the rich side, depending on the identified cylinder. A description will be given of an example of the specific control (the control at the time of EGR blockage) with reference to a flowchart of FIG. 7.

A control routine of FIG. 7 is repeatedly executed at every predetermined time period (e.g., 4 msec) in the ECU 200. In this example, for the sake of convenience, the exhaust gas discharged from the first cylinder #1 and the third cylinder #3 of the engine 1 is assumed to strongly contact the front air-fuel ratio sensor 37, and the exhaust gas discharged from the second cylinder #2 and the fourth cylinder #4 of the engine 1 is assumed to weakly contact the front air-fuel ratio sensor 37.

When the control routine of FIG. 7 is started, first in Step ST101, it is determined whether or not the EGR gas is being introduced based on the opening of the EGR valve 93 (a command value). In a case where the determination result is negative (NO) (in a case where the EGR gas is not being introduced (the EGR valve 93 is closed: the opening=0)), the process proceeds to Step ST110. A control in Step ST110 in this case (a normal control) is a control in a case where no EGR gas is introduced (the EGR rate=0%) at a normal time, that is, the air-fuel ratio of the exhaust gas is controlled through feedback using learned values learned (updated) in the air-fuel ratio feedback control in the case where no EGR gas is introduced (a learned value of the correction amount of the main feedback control and a learned value of the correction amount of the sub feedback control).

In a case where the determination result in Step ST101 is affirmative (YES) (in a case where the EGR gas is being introduced), the process proceeds to Step ST102.

In Step ST102, based on the output signal of the front air-fuel ratio sensor 37, an A/F gradient αa (see FIG. 6) during the introduction of the EGR gas is calculated. Specifically, for example, the change amount (the previous value−the present value) of the output of the front air-fuel ratio sensor 37 in an arithmetic calculation interval of the control routine (sampling time: e.g., 4 msec) is calculated and the A/F gradient αa is thereby determined. Note that, with regard to the air-fuel ratio gradient αa, the change amount (the previous value−the present value=ΔAF) of the output of the front air-fuel ratio sensor 37 at every sampling time mentioned above in the section from the lean peak Pl to the rich peak Pr is added up, and a value obtained by dividing the added-up value (the sum of the air-fuel ratio gradient) by the number of times of the addition may be used as the air-fuel ratio gradient (an added-up average value) αa.

Next, in Step ST103, by using the A/F gradient αa during the introduction of the EGR gas calculated in Step ST102 and an A/F gradient αb when the EGR gas is not introduced, an absolute value of a difference between the A/F gradient αa and the A/F gradient αb (|αa−αb|) is calculated. Subsequently, it is determined whether or not the calculated gradient difference (|αa−αb|) is larger than a predetermined determination threshold value Th.

Note that the A/F gradient αb used for the determination in Step ST103 is acquired in advance using the same arithmetic processing operation as that described above based on the output signal of the front air-fuel ratio sensor 37 (the A/F sensor waveform) when the EGR valve 93 is closed (when the EGR gas is not introduced). Note that, in a case where the A/F gradient αb is not acquired, the A/F gradient αb (an initial value) at the time when the EGR gas is not introduced, which is preset by means of experiment, calculation, or the like, is used.

In a case where the determination result in Step ST103 is negative (NO) (in a case where |αa−αb|≦Th is satisfied), it is determined that the EGR blockage does not occur, and the process proceeds to Step ST110. A control in Step ST110 in this case (a normal control) is a control during the introduction of the EGR gas at the normal time, that is, the air-fuel ratio of the exhaust gas is controlled through feedback using the learned values learned (updated) in the air-fuel ratio feedback control during the introduction of the EGR gas (the learned value of the correction value of the main feedback control and the learned value of the correction amount of the sub feedback control).

On the other hand, in a case where the determination result in Step ST103 is affirmative (YES) (in a case where |αa−αb|>Th is satisfied), it is determined that the EGR blockage occurs (Step ST104).

With regard to the determination threshold value Th used for the determination in Step ST103, for example, the A/F gradient αb when the EGR gas is not introduced (when the EGR valve 93 is closed) and the A/F gradient αa when the EGR blockage (the clogging in the branch EGR passage 91b) occurs in any one of the four cylinders (#1, #2, #3, and #4) are acquired in advance by means of experiment, calculation, or the like. Subsequently, based on the acquired A/F gradient αa and A/F gradient αb, an upper limit value of a difference therebetween |αa−αb| (a permissible value with which it can be determined that the EGR blockage does not occur) is determined by means of experiment, calculation, or the like, and a value obtained based on the upper limit value is set as the determination threshold value Th.

Next, in Step ST105, the cylinder in which the EGR blockage occurs is identified. The identification method will be described. First, in the cylinder in which the EGR blockage occurs, knocking is more likely to occur than in the other cylinders (cylinders in which the EGR blockage does not occur). That is, in the case of the cylinder corresponding to the branch EGR passage 91b in which the clogging occurs, the amount of the EGR gas for the cylinder is reduced to be smaller than those in other cylinders (or the amount of the EGR gas for the cylinder is reduced to 0), and hence the ratio of the amount of new air to the amount of the EGR gas is increased, the air-fuel mixture is thereby brought into a more combustible state, and knocking becomes likely to occur. By utilizing this fact, with the knocking signal output by the knock sensor 40 and the above cylinder recognition process based on the output signals of the crank position sensor 31 and the cam position sensor 39, the cylinder related to the maximum knocking signal (i.e., the cylinder with maximum knocking intensity) is recognized from among the four cylinders (#1, #2, #3, and #4), and the cylinder is identified as the EGR blockage cylinder.

In a case where there is provided a knock control system (KCS) that controls the occurrence of knocking by using the output signal of the knock sensor 40, the EGR blockage cylinder (the cylinder having the maximum retard amount) may also be determined (identified) based on a difference in the retard amount of a retard control for retarding the ignition timing based on the knocking signal output by the nock sensor 40. In addition, in a case where there is provided an in-cylinder pressure sensor that detects the in-cylinder pressure of each cylinder, the EGR blockage cylinder may also be determined (identified) based on an output signal of the in-cylinder pressure sensor.

Next, in Step ST106, it is determined whether or not the main feedback control is being executed. In a case where the determination result is negative (NO) (in a case where the main feedback control is not executed due to, e.g., the start of the engine or fuel cut), the process proceeds to Step ST110. A control in Step ST110 in this case (the normal control) is a control in a case where the main feedback control is not executed and, for example, an air-fuel ratio open control is executed using a learned value (an initial value) immediately after the engine start.

In a case where the determination result in Step ST106 is affirmative (YES), i.e., in a situation where the EGR blockage occurs (in a situation where the EGR blockage cylinder is identified), when the main feedback control is being executed, the process proceeds to Step ST107.

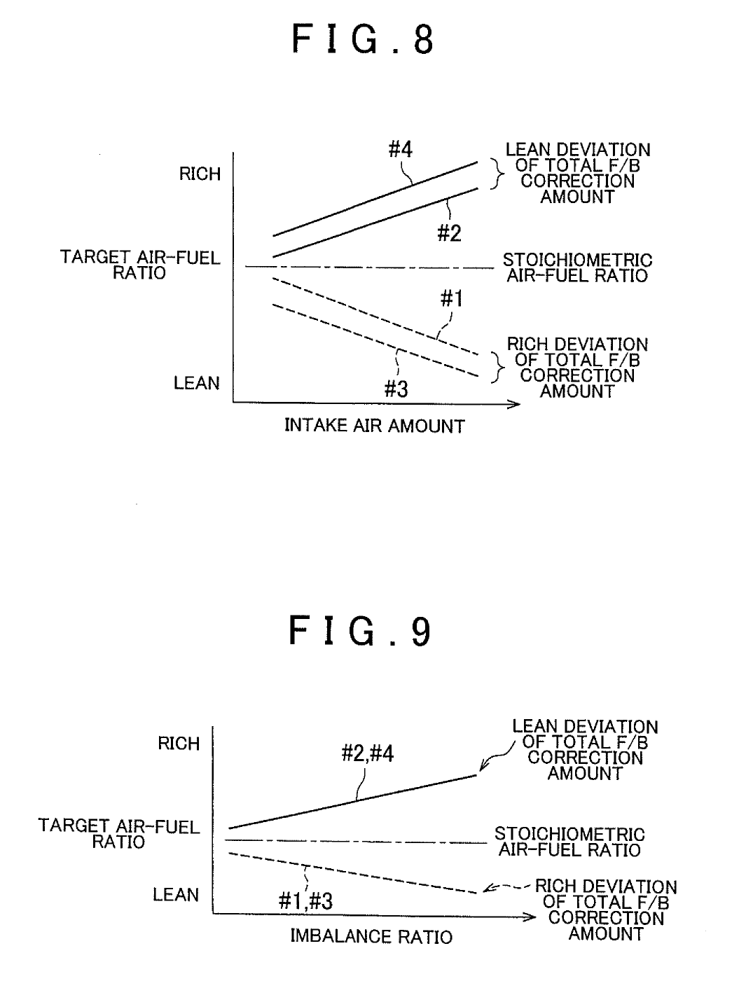

In Step ST107, the target air-fuel ratio is set according to the EGR blockage cylinder. Specifically, the target air-fuel ratio at the time of the EGR blockage is determined and set by referring to a map shown in FIG. 8 based on the cylinder identified in Step ST105 (the EGR blockage cylinder) and the intake air amount calculated from the output signal of the air flow meter 33.

For example, in a case where the cylinder identified in Step ST105 (the EGR blockage cylinder) is the first cylinder #1 or the third cylinder #3, the target air-fuel ratio at the time of the EGR blockage is set to a value leaner than the stoichiometric air-fuel ratio and the main feedback control is executed. Further, the sub feedback control is executed such that the output of the front air-fuel ratio sensor 37 matches the target air-fuel ratio at the time of the EGR blockage (the value on the lean side).

In a case where the cylinder identified in Step ST105 (the EGR blockage cylinder) is the second cylinder #2 or the fourth cylinder #4, the target air-fuel ratio at the time of the EGR blockage is set to a value richer than the stoichiometric air-fuel ratio and the main feedback control is executed. Further, the sub feedback control is executed such that the output of the front air-fuel ratio sensor 37 matches the target air-fuel ratio at the time of the EGR blockage (the value on the rich side).

Herein, the map shown in FIG. 8 is a map created in consideration of that the excess or deficiency of the air-fuel ratio feedback amount is caused by the cylinder in which the EGR blockage occurs, due to the influence resulting from the hardware structure or the like. Specifically, in this example, among the four cylinders (#1, #2, #3, and #4) of the engine 1, the exhaust gas discharged from the first cylinder #1 and the third cylinder #3 is assumed to strongly contact the front air-fuel ratio sensor 37. Therefore, in a case where the clogging (the EGR blockage) occurs in the branch EGR passage 91b corresponding to the first cylinder #1 or the third cylinder #3, the above-described rich deviation (the rich deviation of the total feedback correction amount) occurs. In consideration of this fact, in the map of FIG. 8, the target air-fuel ratio (a changed value) at the time of the EGR blockage is set to be leaner than the stoichiometric air-fuel ratio (see a broken line shown in FIG. 8) in the case of each of the first cylinder #1 and the third cylinder #3. Further, in consideration of that the above-described rich deviation is larger as the intake air amount is larger, the target air-fuel ratio at the time of the EGR blockage (the target air-fuel ratio of each of the first cylinder #1 and the third cylinder #3) is set to become leaner as the intake air amount is larger.

In addition, in this example, the exhaust gas discharged from the second cylinder #2 and the fourth cylinder #4 is assumed to weakly contact the front air-fuel ratio sensor 37. Thus, in consideration of that the above-described lean deviation (the lean deviation of the total feedback correction amount) occurs in a case where the clogging (the EGR blockage) occurs in the branch EGR passage 91b corresponding to the second cylinder #2 or the fourth cylinder #4, in the map of FIG. 8, the target air-fuel ratio (the changed value) at the time of the EGR blockage is set to be richer than the stoichiometric air-fuel ratio (see a solid line shown in FIG. 8) in the case of each of the second cylinder #2 and the fourth cylinder #4. Further, in consideration of that the above-described lean deviation is larger as the intake air amount is larger, the target air-fuel ratio at the time of the EGR blockage (the target air-fuel ratio of each of the second cylinder #2 and the fourth cylinder #4) is set to become richer as the intake air amount is larger.

The map of FIG. 8 is created by mapping the target air-fuel ratio (the target air-fuel ratio at the time of the EGR blockage) obtained such that the actual exhaust gas air-fuel ratio matches the stoichiometric air-fuel ratio, by means of experiment, calculation, or the like, in consideration of the above-described rich deviation and lean deviation caused by the EGR blockage, using the intake air amount as the parameter. The map of FIG. 8 is stored in the ROM 202 of the ECU 200.

Note that a map similar to the map shown in FIG. 8 may be created by using the engine rotational speed and load as the parameters instead of the intake air amount, and the target air-fuel ratio at the time of the EGR blockage may be set.

(Effect) Thus, according to the control of this example, in the case where a clogging occurs in a branch EGR passage 91b among the branch EGR passages 91b through which a part of the exhaust gas is recirculated to the respective cylinders, the cylinder corresponding to the branch EGR passage 91b in which the clogging occurs is identified. Subsequently, in the case where the clogging in the branch EGR passage 91b corresponding to the identified cylinder causes the deviation of the feedback correction amount to the rich side, the target air-fuel ratio is set to be leaner than the stoichiometric air-fuel ratio. In addition, in the case where the clogging in the branch EGR passage 91b corresponding to the identified cylinder causes the deviation of the feedback correction amount to the lean side, the target air-fuel ratio is set to be richer than the stoichiometric air-fuel ratio. Thus, it is possible to set the target air-fuel ratio of the air-fuel ratio feedback control with improved accuracy. With this, it is possible to suppress the deterioration of the exhaust gas emission.

In the above example, although, by using the map (FIG. 8) having the intake air amount as the parameter, the target air-fuel ratio at the time of the EGR blockage is set to be variable according to the intake air amount, the target air-fuel ratio at the time of the EGR blockage may also be set to be variable according to other parameters.

For example, as shown in FIG. 9, by using a map in which the inter-cylinder air-fuel ratio imbalance ratio is used as the parameter and the target air-fuel ratio is set for each of the cylinders, the target air-fuel ratio at the time of the EGR blockage may also be set by referring to the map of FIG. 9 based on the EGR blockage cylinder (the identified cylinder) and the imbalance ratio in the case where the EGR blockage occurs. In this case, with regard to the imbalance ratio, the relationship between the above A/F gradient α and the imbalance ratio may be determined in advance by means of experiment, calculation, or the like, and the determined relation may be mapped, and the imbalance ratio may appropriately be determined by referring to the map based on the A/F gradient αa calculated in Step ST102.

In the map of FIG. 9, in consideration of that the rich deviation relating to each of the first cylinder #1 and the third cylinder #3 is larger as the inter-cylinder air-fuel ratio imbalance ratio is larger, the target air-fuel ratio at the time of the EGR blockage is set to become leaner as the imbalance ratio is larger. In addition, in consideration of that the lean deviation relating to each of the second cylinder #2 and the fourth cylinder #4 is larger as the inter-cylinder air-fuel ratio imbalance ratio is larger, the target air-fuel ratio at the time of the EGR blockage is set to be richer as the imbalance ratio is larger.

The map of FIG. 9 is created by mapping the target air-fuel ratio (the target air-fuel ratio at the time of the EGR blockage) obtained such that the actual exhaust gas air-fuel ratio matches the stoichiometric air-fuel ratio, by means of experiment, calculation, or the like, in consideration of the above-described rich deviation and lean deviation caused by the EGR blockage, using the inter-cylinder air-fuel ratio imbalance ratio as the parameter. The map of FIG. 9 is stored in the ROM 202 of the ECU 200.

Note that a map similar to the map shown in FIG. 9 may be created by using the degree of blockage (the degree of clogging) of the branch EGR passage 91b as the parameter instead of the imbalance ratio, and the target air-fuel ratio at the time of the EGR blockage may be set. In this case, the degree of blockage (the degree of clogging) may be determined by referring to a map or the like, using the above A/F gradient α (see FIG. 6) calculated based on the output signal of the front air-fuel ratio sensor 37.

In addition, the target air-fuel ratio at the time of the EGR blockage may also be set by using the intake air amount and the imbalance ratio as the parameters. In this case, for example, the target air-fuel ratio at the time of the EGR blockage is determined by referring to the map shown in FIG. 8, based on the identified cylinder and the intake air amount obtained from the output signal of the air flow meter 33, and a correction coefficient is determined by referring to a map (e.g., a map similar to the map of FIG. 9, in which the vertical axis indicates the correction coefficient), based on the above imbalance ratio. Subsequently, the target air-fuel ratio at the time of the EGR blockage may also be set by multiplying the target air-fuel ratio determined from the intake air amount by the correction coefficient.

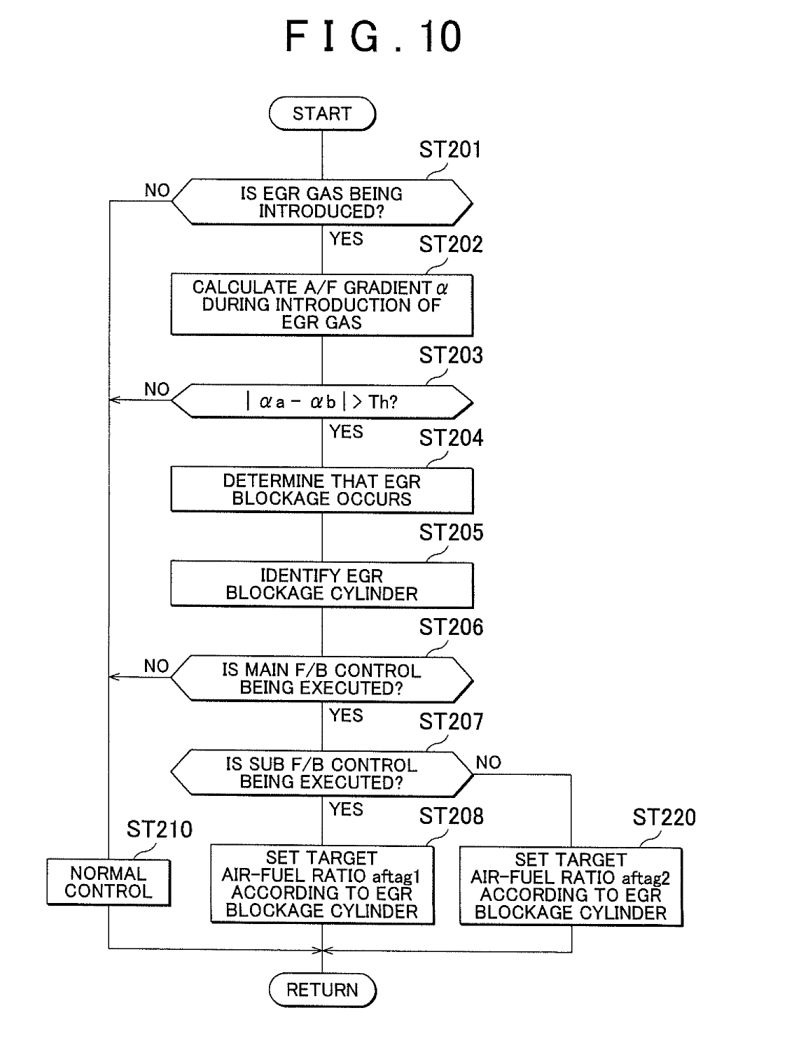

(First modification) Next, a description will be given of another example of the control at the time of the EGR blockage with reference to a flowchart of FIG. 10. A control routine of FIG. 10 is executed by the ECU 200. Note that, in this example as well, for the sake of convenience, the exhaust gas discharged from the first cylinder #1 and the third cylinder #3 of the engine 1 is assumed to strongly contact the front air-fuel ratio sensor 37, and the exhaust gas discharged from the second cylinder #2 and the fourth cylinder #4 of the engine 1 is assumed to weakly contact the front air-fuel ratio sensor 37.

Processes of Steps ST201 to ST206 and Step ST210 shown in FIG. 10 are the same as those of Steps ST101 to ST106 and Step ST110 of the flowchart of FIG. 7, and therefore, a detailed description thereof will be omitted.

In this example, in a case where the determination result in Step ST206 is affirmative (YES), i.e., in a situation where the EGR blockage occurs (in a situation where the EGR blockage cylinder is identified), when the main feedback control is being executed, the process proceeds to Step ST207.

In Step ST207, it is determined whether or not the sub feedback control is being executed. In a case where the determination result is affirmative (YES), the process proceeds to Step ST208.

In Step ST208, a target air-fuel ratio aftag1 is set according to the EGR blockage cylinder. Specifically, for example, the target air-fuel ratio of the front air-fuel ratio sensor 37 (the value on the lean side or the rich side) is determined by referring to the map of FIG. 8, based on the EGR blockage cylinder identified in Step ST205 and the intake air amount calculated from the output signal of the air flow meter 33, and a target value of the sub feedback control (a target voltage value of the rear O₂ sensor 38 at the time of the EGR blockage), with which the determined target air-fuel ratio is achieved, is determined. Subsequently, the main feedback control and the sub feedback control are executed based on the target air-fuel ratio (inclusive of the target value of the sub feedback control) aftag1 determined in this manner.

On the other hand, in a case where the determination result in Step ST207 is negative (NO) (e.g., in a case where the sub feedback control is not executed due to, e.g., catalyst warm-up or the like), the process proceeds to Step ST220.

In Step ST220, a target air-fuel ratio aftag2 (the air-fuel ratio shown below +the learned value of the sub feedback control) is set according to the EGR blockage cylinder. Specifically, with regard to the main feedback control, the target air-fuel ratio of the front air-fuel ratio sensor 37 (the value on the lean side or the rich side) is determined by the same process as that described above, and the main feedback control is executed based on the target air-fuel ratio at the time of the EGR blockage. On the other hand, with regard to the air-fuel ratio control based on the output signal of the rear O₂ sensor 38, the sub feedback control is not executed in this situation, and therefore, the air-fuel ratio open control is executed by using the learned value of the previous sub feedback control.

(Effect) In the control of this modification as well, in the case where a clogging occurs in a branch EGR passage 91b among the plurality of branch EGR passages 91b, the cylinder corresponding to the branch EGR passage 91b in which the clogging occurs is identified and, in the case where the clogging in the branch EGR passage 91b corresponding to the identified cylinder causes the deviation of the feedback correction amount to the rich side, the target air-fuel ratio is set to be leaner than the stoichiometric air-fuel ratio. On the other hand, in the case where the clogging in the branch EGR passage 91b corresponding to the identified cylinder causes the deviation of the feedback correction amount to the lean side, the target air-fuel ratio is set to be richer than the stoichiometric air-fuel ratio. Therefore, it is possible to set the target air-fuel ratio of the air-fuel ratio feedback control with improved accuracy. With this, it is possible to suppress the deterioration of the exhaust gas emission.

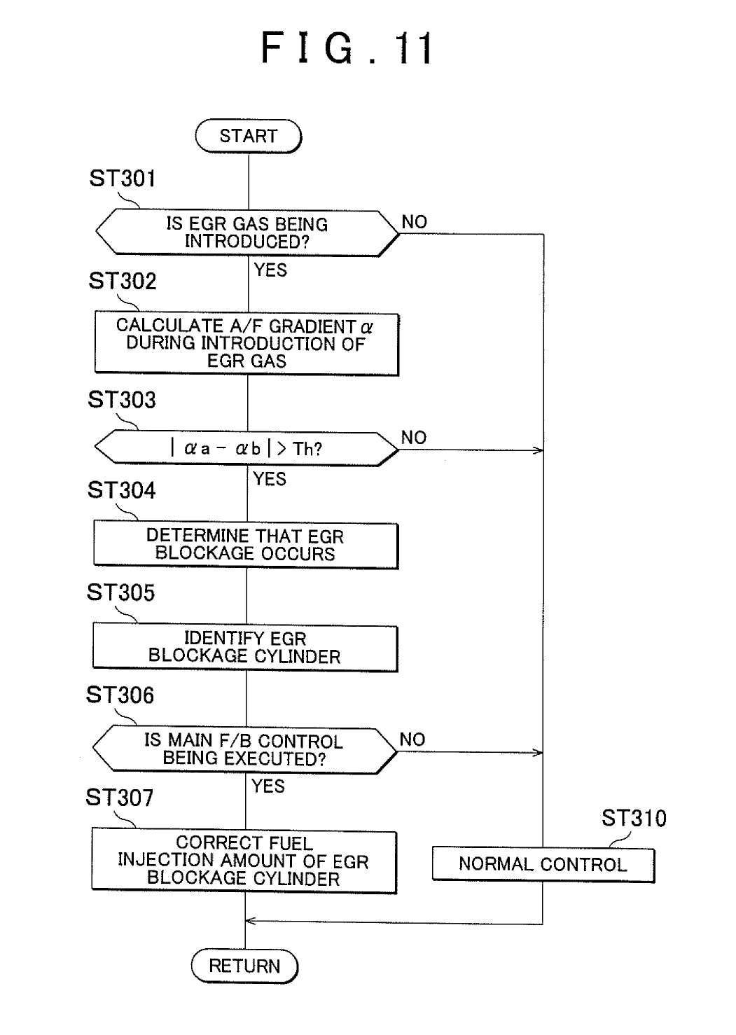

(Second modification) Next, a description will be given of another example of the control at the time of the EGR blockage with reference to a flowchart of FIG. 11. A control routine of FIG. 11 is executed by the ECU 200. Note that, in this example as well, for the sake of convenience, the exhaust gas discharged from the first cylinder #1 and the third cylinder #3 of the engine 1 is assumed to strongly contact the front air-fuel ratio sensor 37, and the exhaust gas discharged from the second cylinder #2 and the fourth cylinder #4 of the engine 1 is assumed to weakly contact the front air-fuel ratio sensor 37.

Processes of Steps ST301 to ST306 and Step ST310 shown in FIG. 11 are the same as those of Steps ST101 to ST106 and Step ST110 of the flowchart of FIG. 7, and therefore, a detailed description thereof will be omitted.

In this example, in a case where the determination result in Step ST306 is affirmative (YES), i.e., in a situation where the EGR blockage occurs (in a situation where the EGR blockage cylinder is identified), when the main feedback control is being executed, the process proceeds to Step ST307.

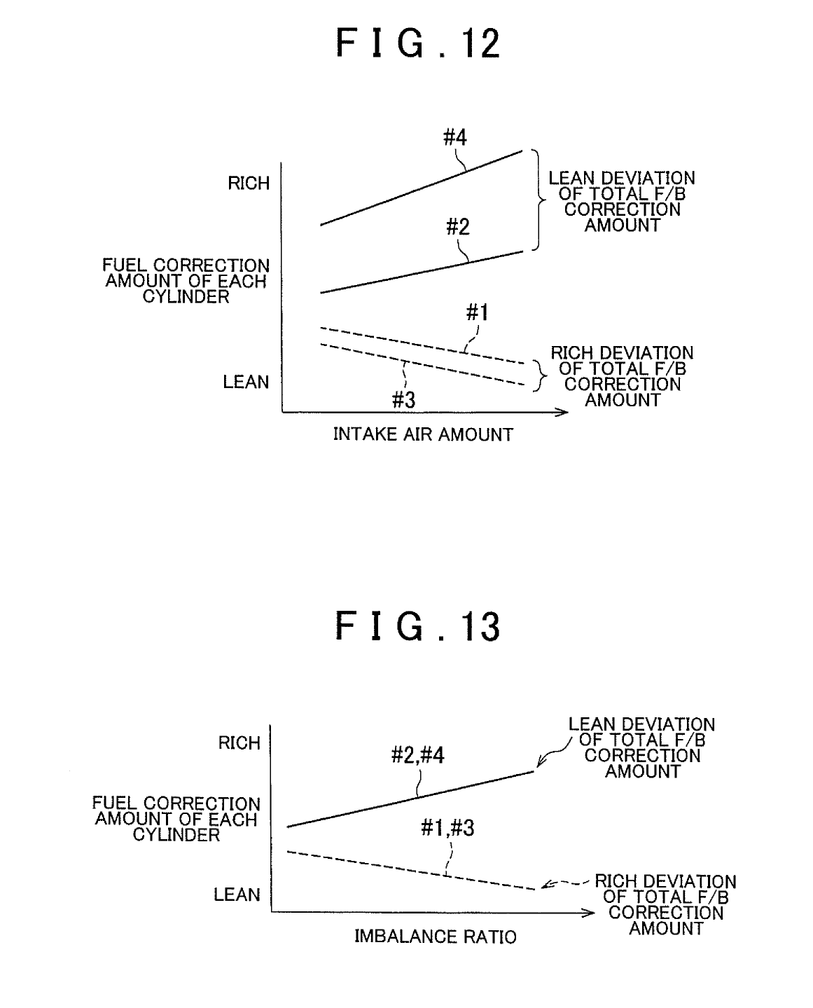

In Step ST307, the fuel injection amount of the EGR blockage cylinder is corrected. Specifically, a correction amount (a fuel correction amount) is determined by referring to a map shown in FIG. 12, based on the EGR blockage cylinder identified in Step ST305 and the intake air amount calculated from the output signal of the air flow meter 33. By using the determined fuel correction amount, the fuel injection amount of the EGR blockage cylinder (a basic fuel injection amount (inclusive of the feedback learned value) set based on the operation state of the engine (the rotational speed, the load, and the like)) is decreased (i.e., correction to the lean side is performed) or increased (i.e., correction to the rich side is performed).

For example, in a case where the cylinder identified in Step ST305 (the EGR blockage cylinder) is the first cylinder #1 or the third cylinder #3, the fuel correction amount is the correction amount on the decrease side (the correction amount for decreasing the fuel injection amount), and the fuel injection amount of the EGR blockage cylinder is corrected using the fuel correction amount on the decrease side. On the other hand, in a case where the cylinder identified in Step ST305 (the EGR blockage cylinder) is the second cylinder #2 or the fourth cylinder #4, the fuel correction amount is the correction amount on the increase side (the correction amount for increasing the fuel injection amount), and the fuel injection amount of the EGR blockage cylinder is corrected using the fuel correction amount on the increase side.

The map shown in FIG. 12 is a map created in consideration of that the excess or deficiency of the fuel injection amount is caused by the cylinder in which the EGR blockage occurs, due to the influence resulting from the hardware structure or the like. Specifically, in this example, the exhaust gas discharged from the first cylinder #1 and the third cylinder #3 among the four cylinders (#1, #2, #3, and #4) of the engine 1 is assumed to strongly contact the front air-fuel ratio sensor 37. Therefore, in a case where the clogging (the EGR blockage) occurs in the branch EGR passage 91b corresponding to the first cylinder #1 or the third cylinder #3, the above-described rich deviation (the rich deviation of the total feedback correction amount) occurs. In consideration of this fact, in the map of FIG. 12, the fuel correction amount at the time of the EGR blockage is set to a value on the decrease side (the lean side), that is, a value for decreasing the fuel injection amount (see the broken line shown in FIG. 12) in the case of each of the first cylinder #1 and the third cylinder #3. Further, in consideration of that the above-described rich deviation is larger as the intake air amount is larger, the fuel correction amount at the time of the EGR blockage (the fuel correction amount of each of the first cylinder #1 and the third cylinder #3) is set to a value further on the decrease side (i.e., the fuel correction amount is set so as to make the fuel injection amount smaller), as the intake air amount is larger.

In addition, in this example, the exhaust gas discharged from the second cylinder #2 and the fourth cylinder #4 is assumed to weakly contact the front air-fuel ratio sensor 37. Therefore, in consideration of that the above-described lean deviation (the lean deviation of the total feedback correction amount) occurs in a case where the clogging (the EGR blockage) occurs in the branch EGR passage 91b corresponding to the second cylinder #2 or the fourth cylinder #4, in the map of FIG. 12, the fuel correction amount at the time of the EGR blockage is set to a value on the increase side (the rich side), that is, a value for increasing the fuel injection amount (the solid line shown in FIG. 12) in the case of each of the second cylinder #2 and the fourth cylinder #4. Further, in consideration of that the above-described lean deviation is larger as the intake air amount is larger, the fuel correction amount at the time of the EGR blockage (the fuel correction amount of each of the second cylinder #2 and the fourth cylinder #4) is set to a value further on the increase side (i.e., the fuel correction amount is set so as to make the fuel injection amount larger), as the intake air amount is larger.

The map shown in FIG. 12 is created by mapping the fuel correction amount (the decrease correction amount or the increase correction amount) obtained by means of experiment, calculation, or the like, in consideration of the above rich deviation and lean deviation caused by the EGR blockage, using the intake air amount as the parameter. The map shown in FIG. 12 is stored in the ROM 202 of the ECU 200.

Note that a map similar to the map shown in FIG. 12 may be created by using the engine rotational speed and load as the parameters instead of the intake air amount, and the fuel correction amount (the increase correction amount or the decrease correction amount) at the time of the EGR blockage may be set.

(Effect) According to this modification, in the case where a clogging occurs in a branch EGR passage 91b among the plurality of branch EGR passages 91b, the cylinder corresponding to the branch EGR passage 91b in which the clogging occurs is identified. In the case where the clogging in the branch EGR passage 91b corresponding to the identified cylinder causes the deviation of the feedback correction amount to the rich side, the fuel injection amount of the identified cylinder is decreased. In addition, in the case where the clogging in the branch EGR passage 91b corresponding to the identified cylinder causes the deviation of the feedback correction amount to the lean side, the fuel injection amount of the identified cylinder is increased. Thus, it is possible to properly execute the air-fuel ratio feedback control. With this, it is possible to suppress the deterioration of the exhaust gas emission.

In this example, although the fuel correction amount (the decrease correction amount or the increase correction amount) for the EGR blockage cylinder is set to be variable according to the intake air amount, by using the map having the intake air amount as the parameter (FIG. 12), the fuel correction amount of the EGR blockage cylinder may also be set to be variable according to other parameters.

For example, as shown in FIG. 13, by using a map in which the inter-cylinder air-fuel ratio imbalance ratio (%) is used as the parameter and the fuel correction amount (the decrease correction amount or the increase correction amount) is set for each of the cylinders, the fuel correction amount (the decrease correction amount or the increase correction amount) at the time of the EGR blockage may also be set by referring to the map of FIG. 13, based on the EGR blockage cylinder (the identified cylinder) and the imbalance ratio in the case where the EGR blockage occurs.

In the map of FIG. 13, in consideration of that the rich deviation relating to each of the first cylinder #1 and the third cylinder #3 is larger as the inter-cylinder air-fuel ratio imbalance ratio is larger, the fuel correction amount is set to a value further on the decrease side (the lean side), that is, the fuel correction amount is set so as to make the fuel injection amount smaller, as the imbalance ratio is larger. In addition, in consideration of that the lean deviation relating to each of the second cylinder #2 and the fourth cylinder #4 is larger as the inter-cylinder air-fuel ratio imbalance ratio is larger, the fuel correction amount is set to a value further on the increase side (the rich side), that is, the fuel correction amount is set so as to make the fuel injection amount larger, as the imbalance ratio is larger.

Note that a map similar to the map shown in FIG. 13 may be created with the degree of blockage (the degree of clogging) of the branch EGR passage 91b used as the parameter instead of the imbalance ratio, and the fuel correction amount (the decrease correction amount or the increase correction amount) at the time of the EGR blockage may be set.

In addition, the fuel correction amount of the EGR blockage cylinder may also be set using the intake air amount and the imbalance ratio as the parameters. In this case, for example, the fuel correction amount of the EGR blockage cylinder is determined by referring to the map shown in FIG. 12, based on the intake air amount obtained from the output signal of the air flow meter 33, and a correction coefficient is determined by referring to a map (e.g., a map similar to the map of FIG. 13, in which the vertical axis indicates the correction coefficient), based on the above imbalance ratio. Subsequently, the fuel correction amount (the decrease correction amount or the increase correction amount) for the EGR blockage cylinder may also be set by multiplying the fuel correction amount determined from the intake air amount by the correction coefficient.

(Other embodiments) Although the branch EGR passages 91b are connected to the intake ports 11a of the respective cylinders (#1, #2, #3, and #4) in the above examples, the invention is not limited thereto, and a structure may such that passages, through which a part of the exhaust gas is recirculated (e.g., passages formed in the cylinder block), are directly connected to the respective cylinders (the respective combustion chambers) and the exhaust gas is recirculated individually to the respective cylinders.

Although it is determined whether the EGR blockage occurs based on the A/F gradient αcalculated from the output signal of the front air-fuel ratio sensor 37 in the above example, the invention is not limited thereto, and it may be determined whether the EGR blockage occurs, by other methods. For example, it may be determined whether the EGR blockage occurs based on the difference ΔAF (see FIG. 6) between the lean peak value AFa and the rich peak value AFb of the above A/F sensor waveform.

Although the invention is applied to the control for the four-cylinder gasoline engine in the above examples, the invention is not limited thereto, and the invention can also be applied to the control for the multi-cylinder internal combustion engine with any number of cylinders such as six cylinders or eight cylinders.

Although the invention is applied to the control for the port-injection multi-cylinder gasoline engine in the above examples, the invention is not limited thereto, and the invention can also be applied to the control for an in-cylinder direct injection multi-cylinder gasoline engine. In addition, the invention can also be applied to the control for a V-type multi-cylinder gasoline engine in addition to an in-line multi-cylinder gasoline engine.

Further, the invention is not limited to the gasoline engine, but the invention can also be applied to the control for, e.g., a flex fuel internal combustion engine in which even alcohol-containing fuel obtained by mixing gasoline and alcohol at any ratio can be used.

Although the invention is applied to the engine control for the conventional vehicle on which only the engine (the internal combustion engine) is mounted in the above examples, the invention is not limited thereto, and the invention can also be applied to the engine control for a hybrid vehicle on which the engine and a motor (a motor generator or a motor) are mounted.

The invention can be used for the control for the multi-cylinder internal combustion engine including a plurality of cylinders and, more specifically, the invention can be effectively used for the control for the internal combustion engine including the EGR device that recirculates a part of the exhaust gas discharged from the cylinders (the combustion chambers) to the exhaust passage, individually to the cylinders.

What is claimed is:

1. A control apparatus for a multi-cylinder internal combustion engine that includes a plurality of cylinders, an exhaust passage, and an exhaust gas recirculation device including a plurality of passages through which a part of exhaust gas discharged into the exhaust passage is recirculated individually to the respective cylinders, the control apparatus comprising
a control unit configured to execute an air-fuel ratio feedback control for controlling an exhaust gas air-fuel ratio to a target air-fuel ratio through feedback using a feedback correction amount, the control unit being configured to identify the cylinder corresponding to the passage in which a clogging occurs, among the plurality of passages, in a case where the clogging occurs in the passage among the plurality of passages, and to set the target air-fuel ratio according to a deviation of the feedback correction amount, the deviation corresponding to the identified cylinder.

2. The control apparatus according to claim 1, wherein the control unit is configured to set the target air-fuel ratio such that the target air-fuel ratio is leaner than a stoichiometric air-fuel ratio in a case where the clogging in the passage corresponding to the identified cylinder causes the deviation of the feedback correction amount to a rich side, and to set the target air-fuel ratio such that the target air-fuel ratio is richer than the stoichiometric air-fuel ratio in a case where the clogging in the passage corresponding to the identified cylinder causes the deviation of the feedback correction amount to a lean side.

3. The control apparatus according to claim 2, wherein the control unit is configured to set the target air-fuel ratio such that the target air-fuel ratio is leaner as an intake air amount is larger in the case where the control unit sets the target air-fuel ratio such that the target air-fuel ratio is leaner than the stoichiometric air-fuel ratio, and to set the target air-fuel ratio such that the target air-fuel ratio is richer as the intake air amount is larger in the case where the control unit sets the target air-fuel ratio such that the target air-fuel ratio is richer than the stoichiometric air-fuel ratio.

4. The control apparatus according to claim 2, wherein the control unit is configured to set the target air-fuel ratio such that the target air-fuel ratio is leaner as a ratio of an inter-cylinder air-fuel ratio imbalance caused by the clogging in the passage is larger in the case where the control unit sets the target air-fuel ratio such that the target air-fuel ratio is leaner than the stoichiometric air-fuel ratio, and to set the target air-fuel ratio such that the target air-fuel ratio is richer as the ratio of the inter-cylinder air-fuel ratio imbalance caused by the clogging in the passage is larger in the case where the control unit sets the target air-fuel ratio such that the target air-fuel ratio is richer than the stoichiometric air-fuel ratio.

5. A control method for a multi-cylinder internal combustion engine that includes a plurality of cylinders, an exhaust passage, and an exhaust gas recirculation device including a plurality of passages through which a part of exhaust gas discharged into the exhaust passage is recirculated individually to the respective cylinders, wherein in the internal combustion engine, an air-fuel ratio feedback control is executed for controlling an exhaust gas air-fuel ratio to a target air-fuel ratio through feedback using a feedback correction amount, the control method comprising:
determining whether or not a clogging occurs in a passage among the plurality of passages;
identifying the cylinder corresponding to the passage in which the clogging occurs in a case where it is determined that the clogging occurs; and
setting the target air-fuel ratio according to a deviation of the feedback correction amount, the deviation corresponding to the identified cylinder.

6. The control method according to claim 5, wherein the target air-fuel ratio is set to be leaner than a stoichiometric air-fuel ratio in a case where the clogging in the passage corresponding to the identified cylinder causes the deviation of the feedback correction amount to a rich side, and the target air-fuel ratio is set to be richer than the stoichiometric air-fuel ratio in a case where the clogging in the passage corresponding to the identified cylinder causes the deviation of the feedback correction amount to a lean side.
